(19) United States
(12) Patent Application Publication
(10) Pub. No.: US 2011/0063091 A1
(43) Pub. Date: Mar. 17, 2011

(54) RADIO FREQUENCY IDENTIFICATION SYSTEM

(75) Inventor: Hee Bok KANG, Cheongju (KR)

(73) Assignee: Hynix Semiconductor Inc., Icheon (KR)

(21) Appl. No.: 12/792,551

(22) Filed: Jun. 2, 2010

(30) Foreign Application Priority Data
Sep. 11, 2009 (KR) 10-2009-0086021
Nov. 25, 2009 (KR) 10-2009-0114414

(51) Int. Cl. H04Q 5/22

(52) U.S. Cl. 340/10.51

(57) ABSTRACT

A radio frequency identification (RFID) system allocates an identification (ID) code to a driving device using an RFID device such that each driving device can be wirelessly controlled at a remote site. The RFID system includes an RFID device which reads and writes data in response to a radio frequency (RF) signal received through an antenna unit. The RFID device includes a connection unit configured to be coupled to an external driving device, and a driving unit configured to output a driving signal for controlling the driving device to the connection unit in response to control signals generated by the RF signal.

### CROSS-REFERENCE TO RELATED APPLICATION

The priority of Korean patent application Nos. 10-2009-114414 and 10-2009-86021, respectively filed on Nov. 25, 2009 and Sep. 11, 2009, the disclosure of which is hereby incorporated in its entirety by reference, is claimed.

### BACKGROUND OF THE INVENTION

Embodiments of the present invention relate to a radio frequency identification (RFID) system, and more specifically, to a technology for identifying an object by communicating with a reader through transmission and reception of a radio frequency (RF) signal.

An RFID tag chip has been widely used to automatically identify objects using an RF signal. In order to automatically identify an object using the RFID tag chip, an RFID tag is attached to the object to be identified, and an RFID reader wirelessly communicates with the RFID tag of the object using a non-contact automatic identification scheme. The widespread use of these RFID technologies, can overcome the shortcomings of a conventional automatic identification technology, such as a barcode and an optical character recognition technology.

In recent times, the RFID tag has been widely used in physical distribution management systems, user authentication systems, electronic money (e-money), transportation systems, and the like.

For example, a physical distribution management system generally performs the classification of goods or management of goods in stock using an Integrated Circuit (IC) recording data therein, instead of using a delivery note or tag. In another example, the user authentication system generally performs an Entrance and Exit Management function or the like using an IC card including personal information or the like.

A non-volatile ferroelectric memory may be used as a memory in an RFID tag.

Generally, a non-volatile ferroelectric memory, i.e., a ferroelectric random access memory (FeRAM), has a data processing speed similar to that of a dynamic random access memory (DRAM), and preserves data even when power is turned off. This has many developers conducting intensive research into FeRAM as a next generation memory device.

The FeRAM has a similar structure to that of DRAM but uses a ferroelectric capacitor as a storage element. Ferroelectric material has a high remnant polarization characteristics, such that data is not lost although an electric field is removed.

FIG. 1 is a block diagram illustrating a general RFID device.

The RFID device generally includes an antenna unit 1, an analog unit 10, a digital unit 20, and a memory unit 30.

The antenna unit 1 receives an RF signal from an external RFID reader. The RF signal received through the antenna unit 1 is input to the analog unit 10 via antenna pads 11 and 12.

The analog unit 10 amplifies the input RF signal and generates a power-supply voltage VDD which can then be used as a driving voltage of an RFID tag. The analog unit 10 detects an operation command signal from the input RF signal, and outputs a command signal CMD to the digital unit 20. In addition, the analog unit 10 detects the output voltage VDD and outputs a power-on reset signal POR controlling a reset operation and a clock CLK to the digital unit 20.

The digital unit 20 receives the power-supply voltage VDD, the power-on reset signal POR, the clock CLK, and the command signal CMD from the analog unit 10, and outputs a response signal RP to the analog unit 10. The digital unit 20 outputs an address ADD, input/output data (I/O), a control signal CTR, and the clock CLK to the memory unit 30. The memory unit 30 reads, writes and stores data using a memory device.

In this case, the RFID device uses frequencies of various bands. In general, as the value of a frequency band is decreased, the RFID device has a lower recognition speed, operates at a shorter distance, and is less affected by the surrounding environment. In contrast, as the value of a frequency band is increased, the RFID device has a higher recognition speed, operates at a greater distance, and is considerably affected by the surrounding environment.

### BRIEF SUMMARY OF THE INVENTION

Various embodiments of the present invention are directed to providing an RFID system that substantially obviates one or more problems due to limitations and disadvantages of the related art.

First, an embodiment of the present invention relates to an RFID technology for allocating an identification (ID) code to a driving device using an RFID device such that each driving device can be wirelessly controlled at a remote site.

Second, an embodiment of the present invention relates to an RFID technology for allocating an ID code to each driving device using an RFID device including an internal or an external sensor, and transmitting a specific driving command to each RFID device using an RF signal, thus establishing a specific output level.

Third, an embodiment of the present invention relates to an RFID technology for allocating an ID code to each driving device using an RFID device including an internal micro-controller unit (MCU) or an external MCU, and transmitting a specific driving command to each RFID device using an RF signal, thus establishing a specific output level.

Fourth, an embodiment of the present invention relates to an RFID device for predetermining handle values for a plurality of RFID devices using a fixed handle mode, and allowing each RFID device to be arbitrarily selected and controlled using the corresponding predetermined handle value, thus increasing the operational efficiency.

In accordance with one embodiment of the present invention, a radio frequency identification (RFID) system including an RFID device which reads and writes data in response to a radio frequency (RF) signal received through an antenna unit includes the RFID device. The RFID device includes a connection unit configured to be coupled to an external driving device; and a driving unit configured to output a driving signal for controlling the driving device to the connection unit in response to control signals generated by the RF signal.

In accordance with another embodiment of the present invention, a radio frequency identification (RFID) system including an RFID device which reads and writes data in response to a radio frequency (RF) signal received through an antenna unit includes the RFID device. The RFID device includes a connection unit configured to be coupled to an external driving device; a sensor control block configured to convert a sensing value detected by a sensing element into digital code data, and output the resultant digital code data; and a driving unit configured to output a driving signal for controlling the driving device to the connection unit in response to the digital code data.

In accordance with another embodiment of the present invention, a radio frequency identification (RFID) system includes an RFID device configured to read and write data in response to a radio frequency (RF) signal received through an antenna unit; and a sensor configured to be coupled to an external part of the RFID device, and output a value detected by a sensing element to the RFID device. The RFID device includes: a connection unit configured to be coupled to an external driving device; a sensor interface unit configured to receive a sensing signal from the sensor; and a driving unit configured to output a driving signal for controlling the driving device to the connection unit in response to an output signal of the sensor interface unit.

In accordance with another embodiment of the present invention, a radio frequency identification (RFID) system including an RFID device which reads and writes data in response to a radio frequency (RF) signal received through an antenna unit includes the RFID device. The RFID device includes a connection unit configured to be coupled to an external driving device; a Micro-Controller Unit (MCU) control block configured to program code data; and a driving unit configured to output a driving signal for controlling the driving device to the connection unit according to output data of the MCU control block.

In accordance with another embodiment of the present invention, a radio frequency identification (RFID) system includes an RFID device configured to read and write data in response to a radio frequency (RF) signal received through an antenna unit; and a micro-controller unit (MCU) processor configured to be coupled to an external part of the RFID device, program code data, and output the programmed code data to the RFID device. The RFID device includes: a connection unit configured to be coupled to an external driving device; a serial interface controller configured to receive code data from the MCU processor; and a driving unit configured to output a driving signal for controlling the driving device to the connection unit in response to an output signal of the serial interface controller.

In accordance with another embodiment of the present invention, a radio frequency identification (RFID) system including an RFID device which reads and writes data in response to a radio frequency (RF) signal received through an antenna unit includes the RFID device. The RFID device includes: a connection unit configured to be coupled to an external driving device; a driving unit configured to output a driving signal for controlling the driving device to the connection unit according to control signals generated by the RF signal; and a fixed handle mode control unit configured to output predetermined fixed handle data to the RFID device at a fixed handle mode according to a command signal generated by the RF signal.

It is to be understood that both the foregoing general description and the following detailed description of the present invention are exemplary and explanatory and are intended to provide further explanation of the invention as claimed.

It will be appreciated by persons skilled in the art that that the effects that can be achieved with the present invention are not limited to what has been particularly described hereinabove and other advantages of the present invention will be more clearly understood from the following detailed description taken in conjunction with the accompanying drawings.

### BRIEF DESCRIPTION OF THE DRAWINGS

FIG. 1 is a block diagram illustrating an RFID device according to a conventional method.

FIG. 2 is a block diagram illustrating an RFID device according to a first embodiment of the present invention.

FIG. 3 is a detailed block diagram illustrating a digital analog converter (DAC) register unit shown in FIG. 2 according to an embodiment of the present invention.

FIG. 4 is a detailed circuit diagram illustrating a non-volatile register shown in FIG. 3 according to an embodiment of the present invention.

FIGS. 5 and 6 are timing diagrams illustrating operation of the non-volatile register shown in FIG. 4 according to an embodiment of the present invention.

FIG. 7 is a flowchart illustrating an operation of the RFID device shown in FIG. 2 according to an embodiment of the present invention.

FIG. 8 is a structural view illustrating an RFID system including the RFID device shown in FIG. 2 according to an embodiment of the present invention.

FIG. 9 is a block diagram illustrating an RFID device according to a second embodiment of the present invention.

FIG. 10 is a block diagram illustrating an RFID device according to a third embodiment of the present invention.

FIG. 11 is a flowchart illustrating an operation of the RFID device shown in FIG. 10 according to an embodiment of the present invention.

FIG. 12 is a structural view illustrating an RFID system including the RFID device shown in FIG. 10.

FIG. 13 is a block diagram illustrating an RFID device according to a fourth embodiment of the present invention.

FIG. 14 is a block diagram illustrating an RFID device according to a fifth embodiment of the present invention.

FIG. 15 is a timing diagram illustrating a programming method for a memory unit shown in FIG. 13.

FIG. 16 is a timing diagram illustrating a method for driving a DAC register unit shown in FIG. 13.

FIG. 17 is a timing diagram illustrating a method for driving the RFID device shown in FIG. 13.

FIG. 18 is a structural view illustrating an RFID system including the RFID device shown in FIG. 14.

FIG. 19 is a flowchart illustrating an operation of the RFID device shown in FIG. 13.

FIG. 20 is a block diagram illustrating an RFID device according to a sixth embodiment of the present invention.

FIG. 21 is a detailed block diagram illustrating a fixed handle mode control unit shown in FIG. 20.

FIG. 22 is a flowchart illustrating an operation of the RFID device shown in FIG. 20.

FIG. 23 is a structural view illustrating an RFID system including the RFID device shown in FIG. 20.

FIGS. 24A to 24D illustrate a power-supply connection relationship of an RFID system according to embodiments of the present invention.

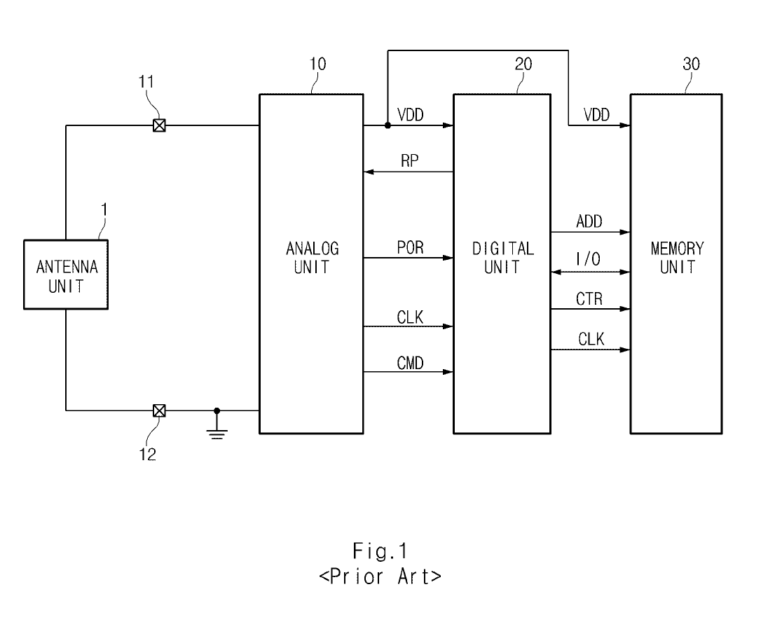

### DESCRIPTION OF EMBODIMENTS

Reference will now be made in detail to the embodiments of the present invention, examples of which are illustrated in the accompanying drawings. Wherever possible, the same reference numbers will be used throughout the drawings to refer to the same or like parts.

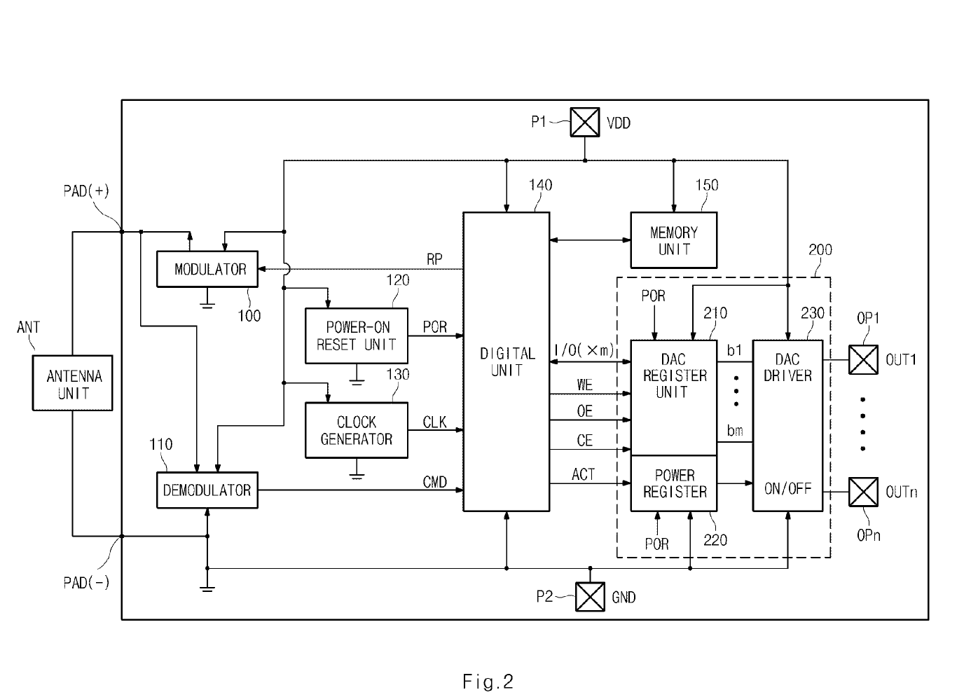

FIG. 2 is a block diagram illustrating a radio frequency identification (RFID) device according to a first embodiment of the present invention.

Referring to FIG. 2, the RFID device includes a modulator 100, a demodulator 110, a power-on reset unit 120, a clock generator 130, a digital unit 140, a memory unit 150, a driving unit 200, a power-supply voltage applying pad P1, a ground voltage applying pad P2, and a plurality of output pads OP1˜OPn. In this case, the driving unit 200 includes a digital analog converter (DAC) register unit 210, a power register 220, and a DAC driver 230.

An antenna unit ANT may be used for data communication between an RFID tag, i.e., the RFID device, and an external reader or writer. The antenna unit ANT is coupled to the RFID tag through antenna pads PAD(+) and PAD(−). In this case, a radio frequency (RF) signal may be used for the RF communication between the RFID device and the external reader or writer.

The modulator 100 modulates a response signal RP received from the digital unit 140, and outputs the modulated response signal to the antenna unit ANT. The demodulator 110 detects an operation command signal from an RF signal received through the antenna unit ANT, and outputs a command signal CMD to the digital unit 140.

The power-on reset unit 120 detects a power-supply voltage VDD received through the power-supply voltage applying pad P1, and outputs a power-on reset signal POR for controlling a reset operation to the digital unit 140. The power-on reset signal POR output from the power-on reset unit 120 is input to the DAC register unit 210 and the power register 220. The clock generator 130 outputs a clock signal CLK to the digital unit 140. The clock signal CLK controls the digital unit 140 in response to the power-supply voltage VDD received from the power-supply voltage applying pad P1.

The digital unit 140 interprets the command signal CMD according to the power-supply voltage VDD from the power-supply voltage applying pad P1, a ground voltage GND from the ground voltage applying pad P2, the power-on reset signal POR, and the clock signal CLK. The digital unit 140 generates control signals and processing signals, such that it outputs the response signal RP to the modulator 100. Furthermore, the digital unit 140 outputs an address ADD, input/output (I/O) data, a control signal CTR, and the clock signal CLK to the memory unit 150.

The digital unit 140 outputs I/O data I/O (using m lines (×m)), a write enable signal WE, an output enable signal OE, and a chip enable signal CE to the DAC register unit 210, and outputs an operation signal ACT to the power register 220.

The memory unit 150 includes a plurality of memory cells, and stores data related to an identification (ID) code specific to each RFID device. Each memory cell writes data in a storage element, and reads data from the storage element.

The memory unit 150 includes a non-volatile memory area. Generally, a ferroelectric random access memory (FeRAM) may be used in the non-volatile memory area. The FeRAM has a data processing speed similar to that of a dynamic random access memory (DRAM). The above-mentioned FeRAM has a similar structure to that of DRAM, and uses a ferroelectric material as a capacitor. The ferroelectric material has high remnant polarization characteristics, such that data is not lost although an electric field is removed.

In this case, the modulator 100, the demodulator 110, the power-on reset unit 120, the clock generator 130, the digital unit 140, the memory unit 150, and the driving unit 200 are driven by the power-supply voltage VDD from the power-supply voltage applying pad P1 and the ground voltage GND from the ground voltage applying pad P2.

In a conventional RFID device, when the RFID device receives the RF signal through communication with the external reader, the power-supply voltage VDD is supplied through a voltage amplification unit provided inside the RFID device. However, in this embodiment, since a large amount of power is consumed by the driving unit 200, the power-supply voltage VDD and the ground voltage GND are provided to the RFID device through the power-supply voltage applying pad P1 and the ground voltage applying pad P2.

The DAC register unit 210 outputs driving control signals b1˜bm to the DAC driver 230, m being a positive integer. In this embodiment, the DAC register unit 210 includes a non-volatile register. The power register 220 outputs a power on/off signal ON/OFF to the DAC driver 230 in response to the operation signal ACT and the power-on reset signal POR. The DAC driver 230 outputs output signals OUT1˜OUTn through the output pads OP1˜OPn, respectively, n being a positive integer.

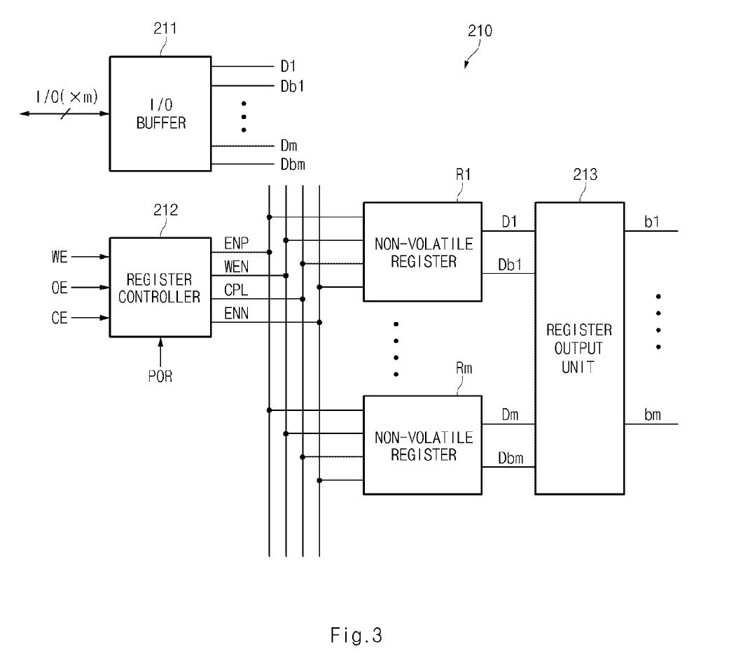

FIG. 3 is a detailed block diagram illustrating the DAC register unit 210 shown in FIG. 2.

Referring to FIG. 3, the DAC register unit 210 includes an I/O buffer 211, a register controller 212, a plurality of non-volatile registers R1˜Rm, and a register output unit 213.

The I/O buffer 211 buffers the I/O data I/O (using m lines (×m)) communicated between the DAC register unit 210 and the digital unit 140. The register controller 212 outputs register control signals upon receiving the write enable signal WE, the output enable signal OE, and the chip enable signal CE from the digital unit 140. The register controller 212 is reset in response to the power-on reset signal POR from the power-on reset unit 120.

In this case, the register control signals include a pull-up enable signal ENP, a write enable signal WEN, a cell plate signal CPL, and a pull-down enable signal ENN.

The non-volatile registers R1˜Rm output data D1˜Dm and Db1˜Dbm upon receiving from the register controller 212 the pull-up enable signal ENP, the write enable signal WEN, the cell plate signal CPL, and the pull-down enable signal ENN. The register output unit 213 controls the output data D1˜Dm and Db1˜Dbm from the registers R1˜Rm, and outputs the driving control signals b1˜bm to the DAC driver 230.

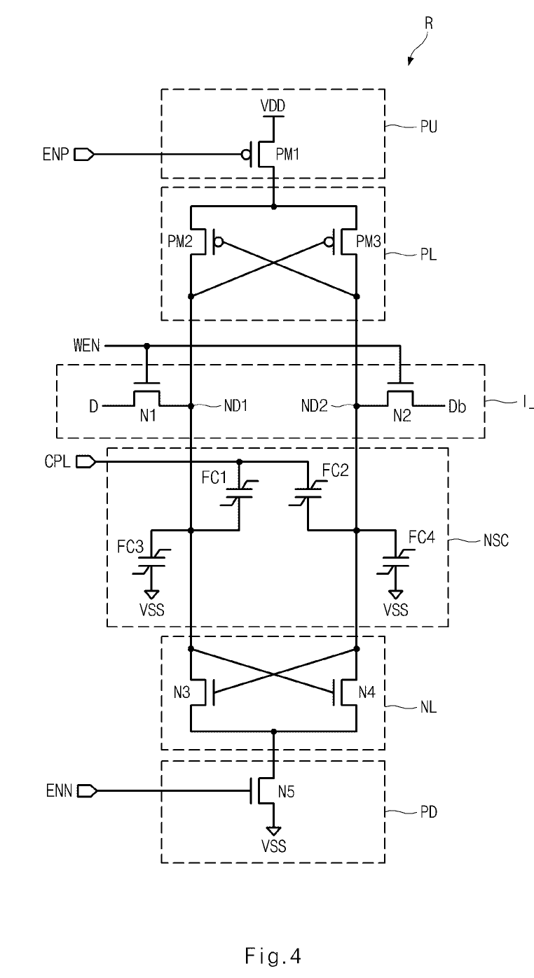

FIG. 4 is a detailed circuit diagram illustrating each of the non-volatile registers R1˜Rm shown in FIG. 3.

Referring to FIG. 4, the non-volatile register R includes a pull-up unit PU, a p-type metal-oxide-semiconductor (PMOS) latch unit (PL), an I/O unit (I_O), a non-volatile ferroelectric capacitor NSC, an n-type metal-oxide-semiconductor (NMOS) latch unit (NL), and a pull-down unit PD.

The pull-up unit PU includes a PMOS transistor PM1. The PMOS transistor PM1 is connected between a power-supply voltage terminal VDD and the PMOS latch unit PL, and receives the pull-up enable signal ENP through a gate terminal.

The PMOS latch unit PL includes PMOS transistors PM2 and PM3. The PMOS transistors PM2 and PM3 are connected between the PMOS transistor PM1 and nodes ND1 and ND2, and the gate terminals of the PMOS transistors PM2 and PM3 are cross-coupled.

The I/O unit I_O includes NMOS transistors N1 and N2. In this case, the NMOS transistor N1 is connected between the node ND1 and a data I/O terminal D, and receives the write enable signal WEN through its gate terminal. The NMOS transistor N2 is connected between the node ND2 and a data I/O terminal Db, and receives the write enable signal WEN through its gate terminal.

The non-volatile ferroelectric capacitor NSC includes a plurality of ferroelectric capacitors FC1˜FC4. The non-volatile ferroelectric capacitors FC1 and FC2 are connected between an input terminal of the cell plate signal CPL and the nodes ND1 and ND2, respectively. The non-volatile ferroelectric capacitors FC3 and FC4 are connected between the nodes ND1 and ND2 and a ground voltage terminal VSS, respectively.

The NMOS latch unit NL includes NMOS transistors N3 and N4. In this case, the NMOS transistors N3 and N4 are connected between the pull-down unit PD and the nodes ND1 and ND2, respectively, and the gate terminals of the NMOS transistors N3 and N4 are cross-coupled with nodes ND2 and ND1, respectively.

The pull-down unit PD includes an NMOS transistor N5. The NMOS transistor N5 is connected between the NMOS latch unit NL and the ground voltage terminal VSS, and receives the pull-down enable signal ENN through its gate terminal.

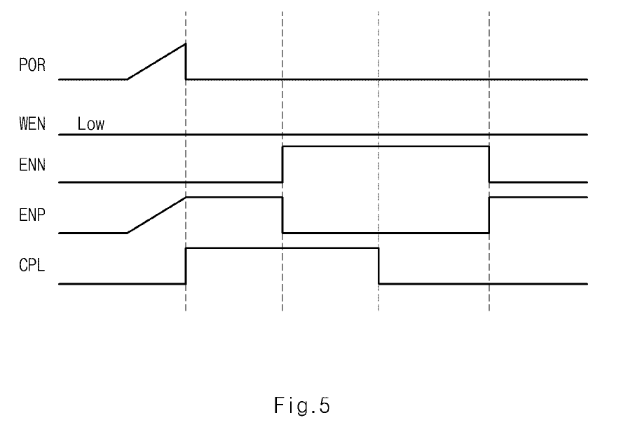

FIG. 5 is a timing diagram illustrating an operation of the non-volatile register R during a power-on operation.

Initially, if a power-on power-supply voltage reaches a power-supply voltage level VDD, the power-on reset signal POR goes low in level such that the RFID chip is reset. If the power-on reset signal POR is transitioned to the low voltage level, the cell plate signal CPL is transitioned to a high level. Therefore, charges stored in the non-volatile ferroelectric capacitors FC1 and FC2 generate a voltage difference between both nodes ND1 and ND2 of a cell due to the capacitance load of the non-volatile ferroelectric capacitors FC3 and FC4. In this case, the write enable signal WEN preserves a low voltage level.

Thereafter, if a sufficient voltage difference occurs between both nodes ND1 and ND2, the pull-up enable signal ENP is activated to a low level, such that the PMOS transistor PM1 is turned on. In addition, the pull-down enable signal ENN is activated to a high level, such that the NMOS transistor N5 is turned on. Therefore, data on both nodes ND1 and ND2 of the cell are driven to VDD or VSS by the PMOS latch unit PL and the NMOS latch unit NL.

Subsequently, if data amplification is completed, the cell plate signal CPL is re-transitioned to a low level, such that high level data of the non-volatile ferroelectric capacitor FC1 or the non-volatile ferroelectric capacitor FC2 is recovered.

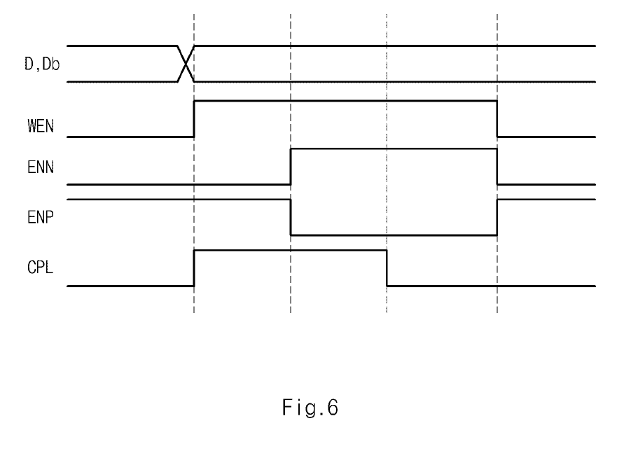

FIG. 6 is a timing diagram illustrating an operation of the non-volatile register R during a program mode.

First, if the power-on reset signal POR preserves a low voltage level, the write enable signal WEN is transitioned to a high voltage level. Accordingly, the NMOS transistors N1 and N2 are turned on, and data D and Db are input to the nodes ND1 and ND2 of the cell, respectively.

At this moment, the cell plate signal CPL is transitioned to a high level. After a predetermined time, the pull-up enable signal ENP is transitioned to a low voltage level, and the pull-down enable signal ENN is transitioned to a high voltage level. Accordingly, the voltage levels of the nodes ND1 and ND2 are stored in a non-volatile way in the non-volatile ferroelectric capacitor NSC.

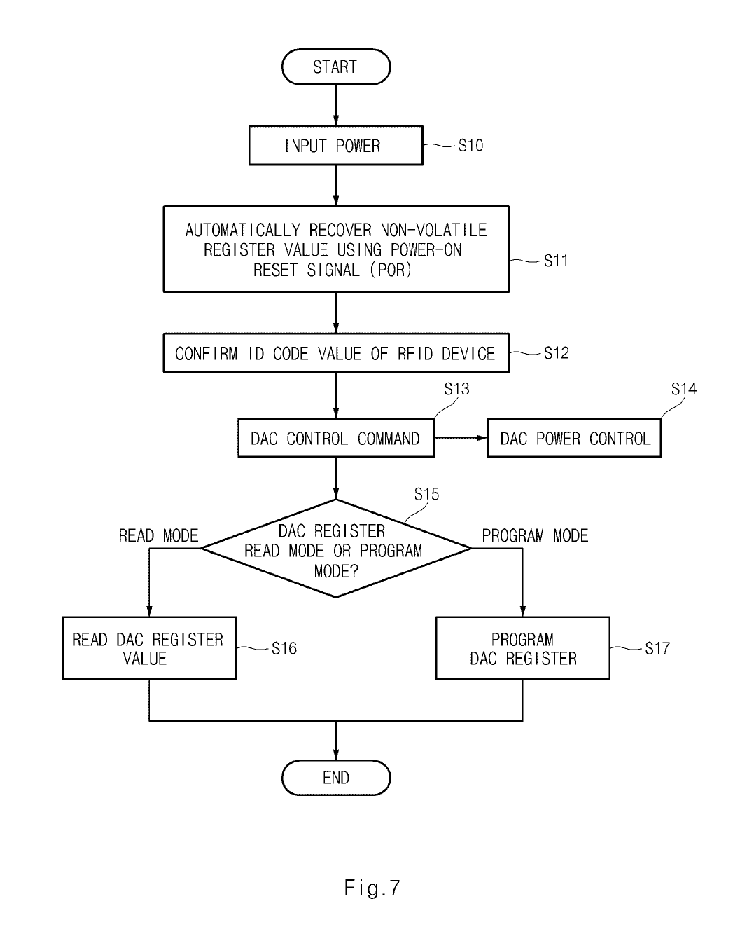

FIG. 7 is a flowchart illustrating an operation of the RFID device shown in FIG. 2 according to an embodiment of the present invention.

Referring to FIG. 7, when the power-supply voltage VDD is input to the RFID device through the power-supply voltage applying pad P1, and the ground voltage GND is input to the RFID device through the ground voltage applying pad P2, the RFID device is powered on at step S10. As a result, values of the non-volatile registers R1˜Rm are automatically recovered by the power-on reset signal POR at step S11.

Therefore, an output status of the DAC driver 230 is decided by initial values of the non-volatile registers R1˜Rm. In other words, the levels of the output signals OUT1˜OUTn are decided by the driving control signals b1˜bm that are output from the DAC register unit 210. The power on/off operation of the DAC driver 230 is controlled in response to the output of the power register 220.

Thereafter, if a read command is input through the antenna unit ANT, the demodulator 110, and the digital unit 140, the RFID device outputs the ID code value stored in the memory unit 150. In other words, the ID code value output from the memory unit 150 is transmitted to an external reader through the digital unit 140, the modulator 100, and the antenna unit ANT at step S12. If a plurality of RFID devices are present, an ID code of each RFID device is recognized, such that a control operation suitable for each recognized ID code can be carried out.

Subsequently, a DAC control command is input to the corresponding RFID device using a designated ID code at step S13. More specifically, the DAC control command is input to the DAC register unit 210 through the antenna unit ANT, the demodulator 110, and the digital unit 140.

If the DAC control command corresponds to a power control command, the power register 220 is activated by the operation signal ACT, such that a register value is established at step S14. The power register 220 outputs a power on/off signal ON/OFF to the DAC driver 230 in response to the power-on reset signal POR and the operation signal ACT.

Thereafter, it is determined whether the DAC control command received through the digital unit 140 is a read command or a program command for controlling the DAC register unit 210 at step S15.

If the DAC control command is the read command (corresponding to a read mode of the DAC register unit 210), the data stored in the DAC register unit 210 is read out at step S16. In other words, data corresponding to the driving control signals b1˜bm stored in the DAC register unit 210 are output. The data output from the DAC register unit 210 are transmitted to the external reader through the digital unit 140, the modulator 100, and the antenna unit ANT.

In contrast, if the DAC control command is the program command corresponding to a program mode of the DAC register unit 210, new data is programmed in the DAC register unit 210 in response to the control signals WE, OE and CE at step S17. Accordingly, the new data is written in the DAC register unit 210, such that the driving control signals b1˜bm are changed.

After that, the DAC register unit 210 outputs a plurality of driving control signals b1˜bm corresponding to the programmed data to the DAC driver 230. The DAC driver 230 outputs driving signals, i.e., the output signals OUT1˜OUTn, through the output pads OP1˜OPn, respectively.

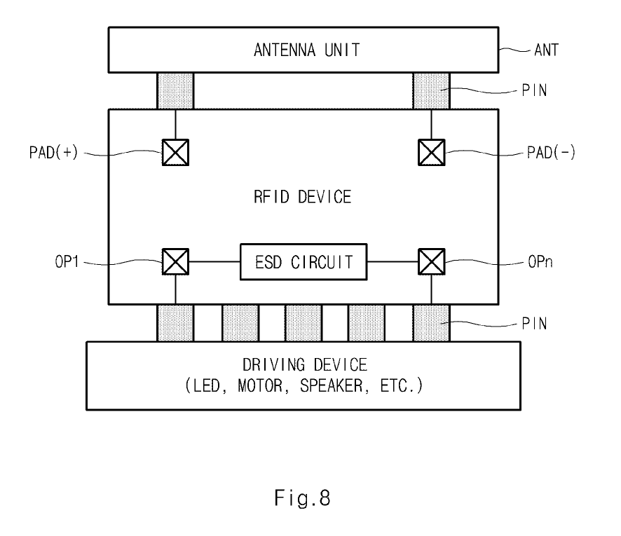

FIG. 8 is a structural view illustrating an RFID system including the RFID device shown in FIG. 2 according to an embodiment of the present invention.

Referring to FIG. 8, the antenna unit ANT is connected to the RFID device through the antenna pads PAD(+) and PAD(−). In other words, the antenna unit ANT is connected to input pins of the RFID device. In addition, the RFID device is connected to an external driving device through the connection pins PIN.

In other words, the output signals OUT1˜OUTn output from the output pads OP1˜OPn of the DAC driver 230 are connected to the driving device through the connection pins PIN. Therefore, the output pads OP1˜OPn may correspond to a connecting unit for connecting the RFID device to the driving device. In this case, the driving device may correspond to a driving control device for controlling a light emitting diode (LED), a motor, a speaker, and the like.

In addition, the RFID system according to an embodiment of the present invention includes an electrostatic discharge (ESD) circuit. The ESD circuit is contained in the RFID device and is connected to the driving device through the output pads OP1˜OPn and the connection pins PIN.

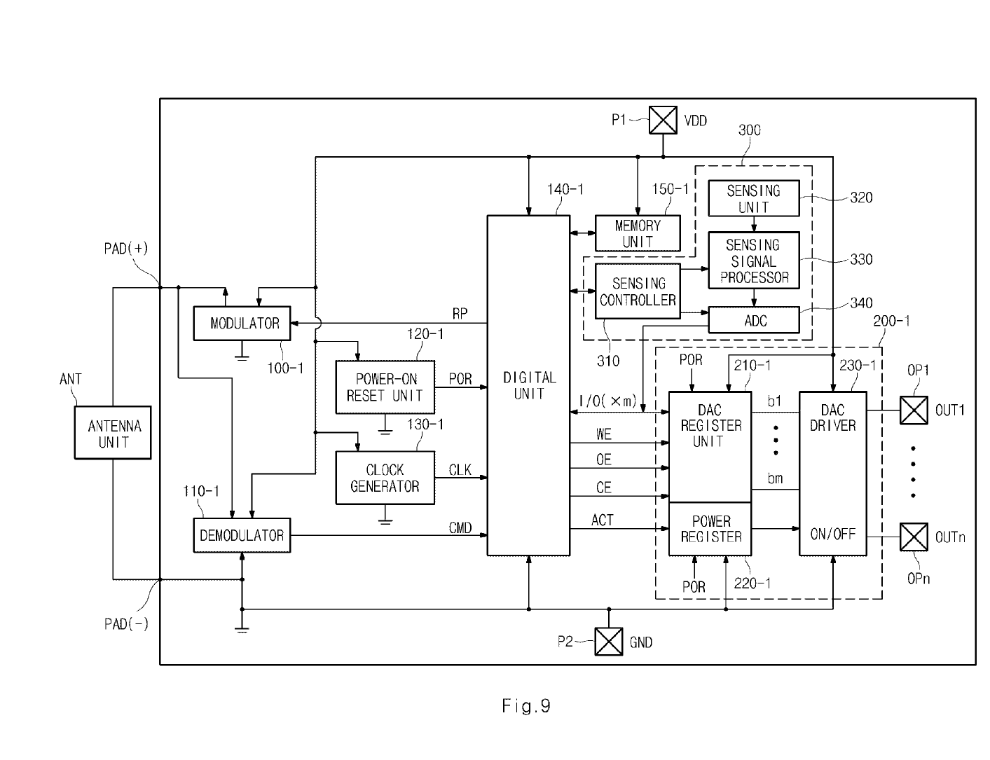

FIG. 9 is a block diagram illustrating an RFID device according to a second embodiment of the present invention

Referring to FIG. 9, the RFID device includes a modulator 100-1, a demodulator 110-1, a power-on reset unit 120-1, a clock generator 130-1, a digital unit 140-1, a memory unit 150-1, a driving unit 200-1, a sensor control block 300, a power-supply voltage applying pad P1, a ground voltage applying pad P2, and a plurality of output pads OP1˜OPn.

The driving unit 200-1 includes a DAC register unit 210-1, a power register 220-1, and a DAC driver 230-1. The sensor control block 300 includes a sensing controller 310, a sensing unit 320, a sensing signal processor 330, and an analog digital converter (ADC) 340.

An antenna unit ANT may be used for data communication between an RFID tag, i.e., the RFID device, and an external reader or writer. The antenna unit ANT is coupled to the RFID tag through antenna pads PAD(+) and PAD(−). In this case, an RF signal may be used for RF communication between the RFID device and the external reader or writer.

The modulator 100-1 modulates a response signal RP received from the digital unit 140-1, and outputs the modulated response signal to the antenna unit ANT. The demodulator 110-1 detects an operation command signal from the RF signal received through the antenna unit ANT, and outputs a command signal CMD to the digital unit 140-1.

The power-on reset unit 120-1 detects a power-supply voltage VDD received through the power-supply voltage applying pad P1, and outputs a power-on reset signal POR for controlling a reset operation to the digital unit 140-1. The power-on reset signal POR output from the power-on reset unit 120-1 is input to the DAC register unit 210-1 and the power register 220-1. The clock generator 130-1 outputs a clock signal CLK to the digital unit 140-1. The clock signal CLK controls the digital unit 140-1 in response to the power-supply voltage VDD received from the power-supply voltage applying pad P1.

The digital unit 140-1 interprets the command signal CMD according to the power-supply voltage VDD from the power-supply voltage applying pad P1, a ground voltage GND from the ground voltage applying pad P2, the power-on reset signal POR, and the clock signal CLK. The digital unit 140-1 generates control signals and processing signals, such that it outputs the response signal RP to the modulator 100-1. Further, the digital unit 140-1 outputs an address ADD, input/output (I/O) data, a control signal CTR, and the clock signal CLK to the memory unit 150-1.

The digital unit 140-1 outputs I/O data I/O (using m lines (×m)), a write enable signal WE, an output enable signal OE, and a chip enable signal CE to the DAC register unit 210-1, and outputs an operation signal ACT to the power register 220-1. In other words, operation signals received from the external reader pass through the antenna unit ANT, the demodulator 110-1, and the digital unit 140-1, and are input to the DAC register unit 210-1 as the write enable signal WE, the output enable signal OE, and the chip enable signal CE.

The memory unit 150-1 includes a plurality of memory cells, and stores data related to an ID code of each RFID device. Each memory cell writes data in a storage element, and reads data from the storage element.

The memory unit 150-1 includes a non-volatile memory area. Generally, an FeRAM may be used as the non-volatile memory area. The FeRAM has a data processing speed similar to that of DRAM. The FeRAM has a similar structure to that of DRAM, and uses a ferroelectric material as a capacitor. The ferroelectric material has high remnant polarization characteristics, such that data is not lost although an electric field is removed.

In this case, the modulator 100-1, the demodulator 110-1, the power-on reset unit 120-1, the clock generator 130-1, the digital unit 140-1, the memory unit 150-1, and the driving unit 200-1 are driven by the power-supply voltage VDD from the power-supply voltage applying pad P1 and the ground voltage GND from the ground voltage applying pad P2.

In a conventional RFID device, when the RFID device receives the RF signal through communication with the external reader, the power-supply voltage VDD is supplied through a voltage amplification unit provided inside the RFID device. However, in this embodiment, since a large amount of power is consumed by the driving unit 200-1 and the sensor control block 300, the power-supply voltage VDD and the ground voltage GND are provided to the RFID device through the power-supply voltage applying pad P1 and the ground voltage applying pad P2.

The DAC register unit 210-1 outputs driving control signals b1˜bm to the DAC driver 230-1. In this embodiment, the DAC register unit 210-1 includes a non-volatile register. The power register 220-1 outputs a power on/off signal ON/OFF to the DAC driver 230-1 in response to the operation signal ACT and the power-on reset signal POR. The DAC driver 230-1 outputs output signals OUT1˜OUTn through the output pads OP1˜OPn, respectively.

An initial setup value (also called ‘initial set value’) of the DAC register unit 210-1 is established by the RF signal received from the antenna unit ANT. Therefore, if a power source of the RFID device is controlled, or if data stored in the DAC register unit 210-1 is read out, the RF signal received from the antenna unit ANT may be used to change the initial setup value.

The sensing controller 310 controls operation of the digital unit 140-1, the sensing signal processor 330, and the ADC 340. The sensing unit 320 includes a variety of sensing elements for detecting various sensing parameters such as temperature, pressure, acceleration, gas, light, and the like. For example, the sensing unit 320 detects the sensing parameters such as temperature, pressure, acceleration, gas, light, etc., as voltage values, converts the detected voltage values into current values, and outputs the current values as a sensing signal. In this embodiment, the sensing element may include a complementary metal-oxide-semiconductor (CMOS) image sensor, a pixel element, a diode element, a resistor element, etc. Therefore, if the sensing parameter is the temperature, a current value corresponding to the detected temperature is output as the sensing signal.

The sensing signal processor 330 compensates for an offset of the sensing signal received from the sensing unit 320, and amplifies the compensated sensing signal.

The ADC 340 converts the sensing signal acting as an analog signal received from the sensing signal processor 330 into digital code data in response to a control signal from the sensing controller 310. The digital code data output from the ADC 340 is transmitted to an I/O data bus, such that it may be input to the digital unit 140-1 or the DAC register unit 210-1 through the I/O data bus.

In this embodiment, the control signals WE, OE and CE may determine whether the digital code data applied to the I/O data bus is to be input to the digital unit 140 or the DAC register unit 210-1.

In other words, the external reader may sometimes recognize sensing data of the sensing unit 320. In this case, in order to transmit the sensing signal of the sensing unit 320 to the external reader, the sensing signal is transmitted to the digital unit 140-1 through the sensing signal processor 330, the ADC 340 and the I/O data bus. Thereafter, the sensing signal is transmitted to the external reader through the demodulator 110-1 and the antenna unit ANT.

In contrast, in order to program new data into the register by outputting the sensing signal of the sensing unit 320 to the DAC register unit 210-1. The sensing signal is transmitted to the DAC register unit 210-1 through the sensing signal processor 330, the ADC 340, and the I/O data bus.

The DAC register unit 210-1 includes an internal register to store the digital code data transmitted from the ADC 340. In addition, the DAC register unit 210-1 compares set data preset by the RF signal with data stored in the internal register and outputs the driving control signals b1˜bm according to the result of the comparison.

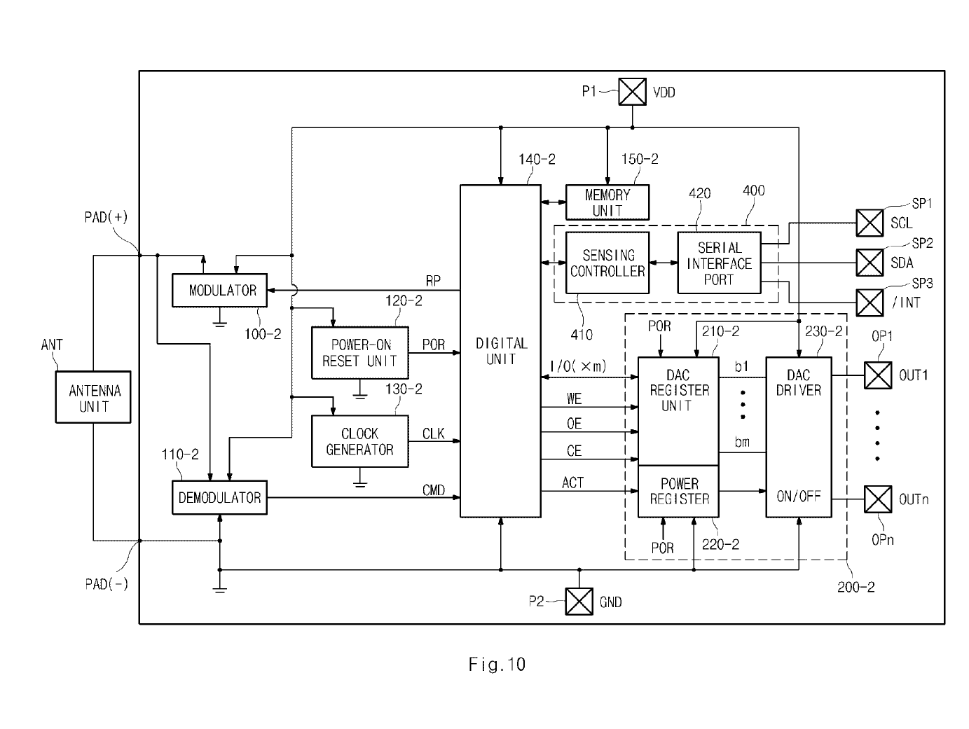

FIG. 10 is a block diagram illustrating an RFID device according to a third embodiment of the present invention.

Referring to FIG. 10, the RFID device includes a modulator 100-2, a demodulator 110-2, a power-on reset unit 120-2, a clock generator 130-2, a digital unit 140-2, a memory unit 150-2, a driving unit 200-2, a sensor interface unit 400, a power-supply voltage applying pad P1, a ground voltage applying pad P2, a plurality of output pads OP1˜OPn, and a plurality of sensing pads SP1˜SP3.

In this embodiment, the driving unit 200-2 includes a DAC register unit 210-2, a power register 220-2, and a DAC driver 230-2. The sensor interface unit 400 includes a sensing controller 410 and a serial interface port 420. In accordance with this embodiment of the present invention, an external sensor is located outside the RFID device. The sensor interface unit 400 receives a sensing signal from the external sensor through the sensing pads SP1˜SP3 to program the DAC register unit 210-2 using the received sensing signal.

An antenna unit ANT may be used for data communication between the RFID device and an external reader or writer. The antenna unit ANT is coupled to the RFID device through antenna pads PAD(+) and PAD(−). In this case, an RF signal may be used for the RF communication between the RFID device and the external reader or writer.

The modulator 100-2 modulates a response signal RP received from the digital unit 140-2, and outputs the modulated response signal to the antenna unit ANT. The demodulator 110-2 detects an operation command signal from the RF signal received through the antenna unit ANT, and outputs a command signal CMD to the digital unit 140-2.

The power-on reset unit 120-2 detects a power-supply voltage VDD received from the power-supply voltage applying pad P1, and outputs a power-on reset signal POR (for controlling a reset operation) to the digital unit 140-2. The power-on reset signal POR output from the power-on reset unit 120-2 is input to the DAC register unit 210-2 and a power register 220-2. The clock generator 130-2 outputs a clock signal CLK to the digital unit 140-2. The clock signal CLK controls the digital unit 140-2 in response to the power-supply voltage VDD received from the power-supply voltage applying pad P1.

The digital unit 140-2 interprets the command signal CMD based on the power-supply voltage VDD from the power-supply voltage applying pad P1, a ground voltage GND from the ground voltage applying pad P2, the power-on reset signal POR, and the clock signal CLK. The digital unit 140-2 generates control signals and processing signals, such that it outputs the response signal RP to the modulator 100-2. Furthermore, the digital unit 140-2 outputs an address ADD, I/O data, a control signal CTR, and the clock signal CLK to the memory unit 150-2.

The digital unit 140-2 outputs I/O data I/O (using m lines (×m)), a write enable signal WE, an output enable signal OE, and a chip enable signal CE to the DAC register unit 210-2, and outputs an operation signal ACT to the power register 220-2. In other words, operation signals received from the external reader pass through the antenna unit ANT, the demodulator 110-2, and the digital unit 140-2, and are input to the DAC register unit 210-2 as the write enable signal WE, the output enable signal OE, and the chip enable signal CE.

The memory unit 150-2 includes a plurality of memory cells, and stores data related to an ID code of each RFID device. Each memory cell writes data in a storage element, and reads data from the storage element.

The memory unit 150-2 includes a non-volatile memory area. Generally, an FeRAM may be used as the non-volatile memory area. The FeRAM has a data processing speed similar to that of DRAM. The FeRAM has a similar structure to that of DRAM, and uses a ferroelectric material as a capacitor. The ferroelectric material has high remnant polarization characteristics, such that data is not lost although an electric field is removed.

In this case, the modulator 100-2, the demodulator 110-2, the power-on reset unit 120-2, the clock generator 130-2, the digital unit 140-2, the memory unit 150-2, and the driving unit 200-2 are driven by the power-supply voltage VDD from the power-supply voltage applying pad P1 and the ground voltage GND from the ground voltage applying pad P2.

In a conventional RFID device, when the RFID device receives the RF signal through communication with the external reader, the power-supply voltage VDD is supplied through a voltage amplification unit provided inside the RFID device. However, in this embodiment, since a large amount of power is consumed by the driving unit 200-2 and the sensor interface unit 400, the power-supply voltage VDD and the ground voltage GND are provided to the RFID device through the power-supply voltage applying pad P1 and the ground voltage applying pad P2.

The DAC register unit 210-2 outputs driving control signals b1˜bm to the DAC driver 230-2. In this embodiment, the DAC register unit 210-2 includes a non-volatile register. The power register 220-2 outputs a power on/off signal ON/OFF to the DAC driver 230-2 in response to the operation signal ACT and the power-on reset signal POR. The DAC driver 230-2 outputs output signals OUT1˜OUTn through the output pads OP1˜OPn, respectively.

An initial setup value (also called ‘initial set value’) of the DAC register unit 210-2 is established by the RF signal received from the antenna unit ANT. Therefore, if a power source of the RFID device is controlled, or if data stored in the DAC register 210-2 is read out, the RF signal received from the antenna unit ANT may be used to change the initial setup value.

The sensing controller 410 controls operation of the digital unit 140-1 and the serial interface port 420. The serial interface port 420 may include an inter-integrated circuit (I2C) port. The serial interface port 420 controls sensing data received from the external sensor to perform a serial interface between the RFID device and the external sensor. The RFID device includes the sensing pads SP1˜SP3 to perform an interfacing operation with the external sensor. The serial interface port 420 receives a clock signal SCL through the sensing pad SP1, data SDA through the sensing pad SP2, and an interrupt signal /INT through the sensing pad SP3.

In this case, the clock signal SCL may be indicative of a serial clock signal used by the I2C port, and the data SDA may be indicative of a serial data open drain used by the I2C port. The interrupt signal /INT may represent an interrupt and data ready signal.

The external sensor located outside the RFID device may include a variety of sensing elements for detecting various sensing parameters such as temperature, pressure, acceleration, gas, light, and the like. For example, the external sensor may detect the sensing parameters such as temperature, pressure, acceleration, gas, light, etc., as voltage values, converts the detected voltage values into current values, and outputs the current values as the sensing signal. In this embodiment, the sensing element may include a CMOS image sensor, a pixel element, a diode element, a resistor element, etc. Therefore, if the sensing parameter is the temperature, a current value corresponding to the detected temperature is output as the sensing signal.

The sensing signal received through the sensing pads SP1˜SP3 is applied to the serial interface port 420. The sensing signal is then applied to the digital unit 140-2 through the sensing controller 410. The digital unit 140-2 compensates for an offset of the sensing signal received from the sensing controller 410, and amplifies the compensated signal. The digital unit 140-2 converts the sensing signal, which is transmitted in the form of an analog signal from the sensing controller 410, into digital code data. The digital code data output from the digital unit 140-2 is transmitted to the DAC register unit 210-2 through an I/O data bus.

In the meantime, the external reader may sometimes recognize a register value of the DAC register unit 210-2. In this case, in order to transmit the register value stored in the DAC register unit 210-2 to the external reader, the stored register value is transmitted to the external reader through the digital unit 140-2, the demodulator 110-2, and the antenna unit ANT.

In contrast, in order to program new data in the DAC register unit 210-2 by using the sensing signal from the external sensor, the sensing signal received through the sensing pads SP1˜SP3 are transmitted to the serial interface port 420. Then, the digital code data is input to the DAC register unit 210-2 through the sensing controller 410, the digital unit 140-2, and the I/O data bus.

The DAC register unit 210-2 includes an internal register to store the digital code data transmitted from the digital unit 140-2. In addition, the DAC register unit 210-2 compares set data preset by the RF signal with data stored in the internal register and outputs the driving control signals b1˜bm according to the result of the comparison.

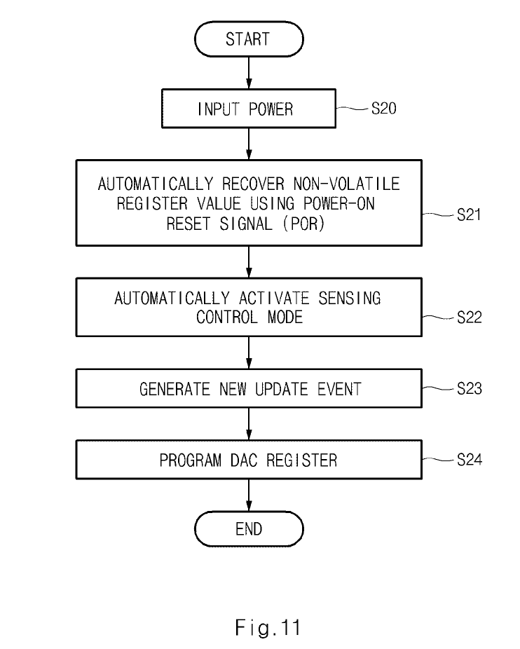

FIG. 11 is a flowchart illustrating an operation of the RFID device shown in FIG. 10 according to an embodiment of the present invention.

Referring to FIG. 11, when the RFID device receives the power-supply voltage VDD from the power-supply voltage applying pad P1 and the ground voltage GND from the ground voltage applying pad P2, the RFID device is powered on at step S20. As a result, a value of the DAC register unit 210-2 is automatically recovered by the power-on reset signal POR at step S21. Accordingly, if a sensing control mode is automatically activated, a control signal corresponding to the sensing signal is automatically generated at step S22.

By the initial setup value of the DAC register unit 210-2 that is recovered, the output state data of the DAC driver 230-2 is decided. That is, levels of the output signals OUT1˜OUTn are decided by the driving control signals b1˜bm output from the DAC register unit 210-2. In addition, a power state of the DAC driver 230-2 is controlled by a state of the power register 220-2.

Thereafter, if the sensing signal of the external sensor is changed, a new update event is generated at step S23. In this case, the sensing signal received through the sensing pads SP1˜SP3 is input to the DAC register unit 210-2 through the serial interface port 420, the sensing controller 410, and the digital unit 140-2.

Therefore, a program mode of the DAC register unit 210-2 is activated, such that new data is programmed in the DAC register unit 210-2 in response to the control signals WE, OE and CE received from the digital unit 140-2 at step S24. Thus, the new data is stored in the DAC register unit 210-2, such that several of the driving control signals b1˜bm are changed to have different values.

Thereafter, the DAC register unit 210-2 outputs the driving control signals b1˜bm corresponding to the programmed data to the DAC driver 230-2. Therefore, the DAC driver 230-2 outputs the output signals OUT1˜OUTn through the output pads OP1˜OPn, respectively.

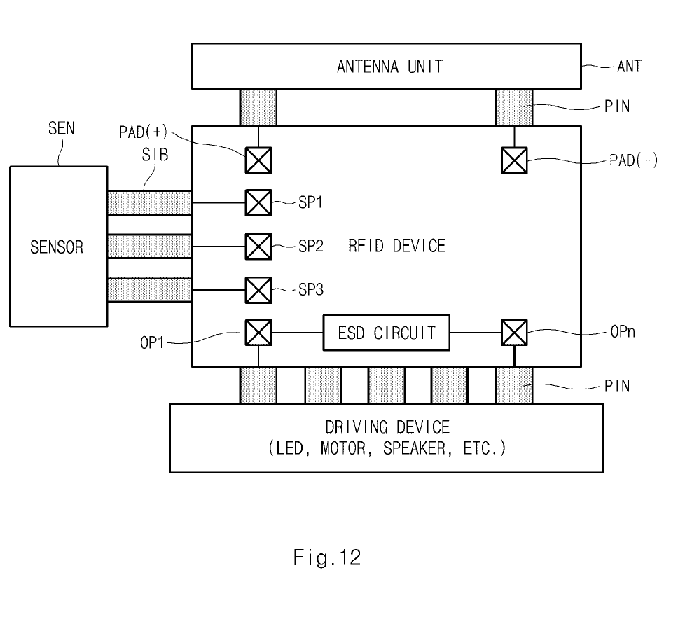

FIG. 12 is a structural view illustrating an RFID system including the external sensor SEN and the RFID device shown in FIG. 10.

Referring to FIG. 12, the antenna unit ANT is connected to the RFID device through the antenna pads PAD(+) and PAD(−). In other words, the antenna unit ANT is connected to the input pins of the RFID device. In addition, the RFID device is connected to the driving device through the connection pins PIN.

In other words, the output signals OUT1˜OUTn transmitted from the output pads OPn˜OPn of the DAC driver 230-2 are input to the driving device through the connection pins PIN. In this case, the driving device may correspond to a driving control device for controlling an LED, a motor, a speaker, and the like.

In addition, the RFID system according to an embodiment of the present invention includes an ESD circuit. The ESD circuit is contained in the RFID device, and connected to the driving device through the output pads OP1˜OPn and the connection pins PIN.

The sensor SEN may be coupled to the RFID device through a serial interface bus (SIB) outside the RFID device. The sensing signal of the sensor SEN may be input to the RFID device through the sensing pads SP1˜SP3 of the RFID device.

The RFID system includes a function of the RFID device for recognizing the ID code and a function of a ubiquitous sensor network (USN) based on the sensor, such that it can control operation of the driving device. Therefore, a user can remotely control the driving device using the RFID device including either the internal sensor or the external sensor.

In this embodiment of the present invention, for convenience of description and better understanding of the present invention, the structure including the modulator 100-2, the demodulator 110-2, the power-on reset unit 120-2, the clock generator 130-2, the digital unit 140-2, the memory unit 150-2, the driving unit 200-2, and the sensor interface unit 400 is referred to as the RFID device. If the external sensor SEN is further added to the above-mentioned structure, the structure including the external sensor SEN is referred to as the RFID system.

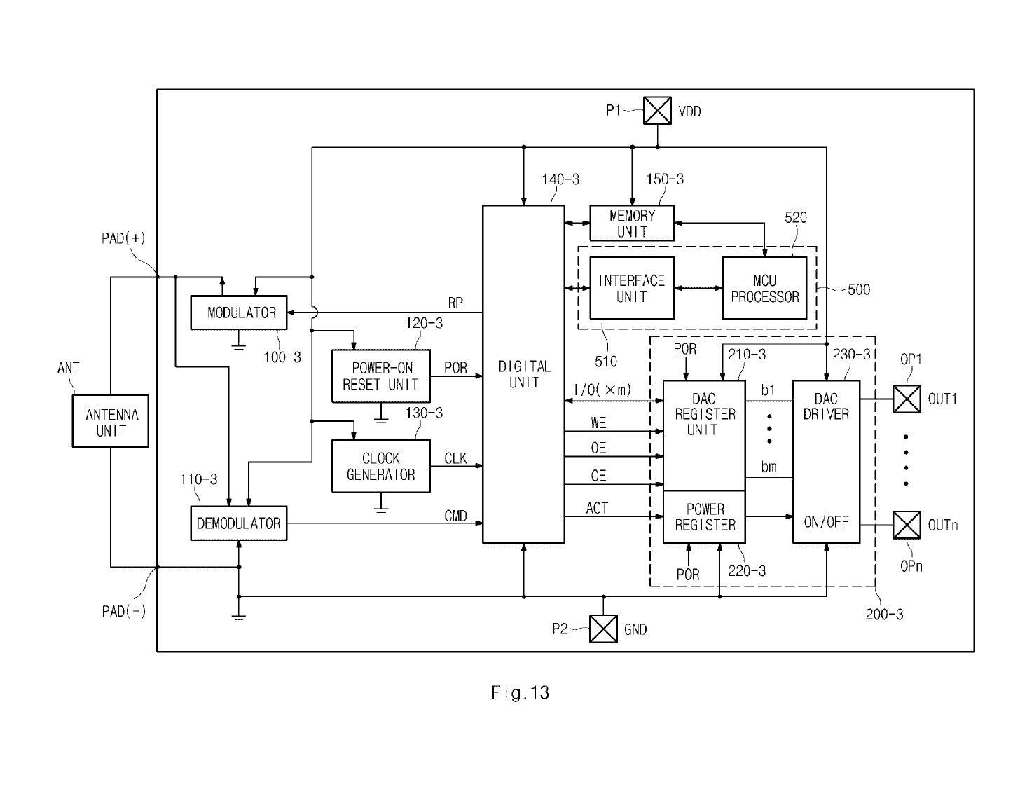

FIG. 13 is a block diagram illustrating an RFID device according to a fourth embodiment of the present invention.

Referring to FIG. 13, the RFID device includes a modulator 100-3, a demodulator 110-3, a power-on reset unit 120-3, a clock generator 130-3, a digital unit 140-3, a memory unit 150-3, a driving unit 200-3, a micro controller unit (MCU) control block 500, a power-supply voltage applying pad P1, a ground voltage applying pad P2, and a plurality of output pads OP1˜OPn.

The driving unit 200-3 includes a DAC register unit 210-3, a power register 220-3, and a DAC driver 230-3. The MCU control block 500 includes an interface unit 510 and an MCU processor 520. In accordance with this embodiment of the present invention, the MCU control block 500 is located inside the RFID device.

An antenna unit ANT may be used for data communication between an RFID tag, i.e., the RFID device, and an external reader or writer. The antenna unit ANT is coupled to the RFID tag through antenna pads PAD(+) and PAD(−). In this case, an RF signal may be used for the RF communication between the RFID device and the external reader or writer.

The modulator 100-3 modulates a response signal RP received from the digital unit 140-3, and outputs the modulated response signal to the antenna unit ANT. The demodulator 110-3 detects an operation command signal from the RF signal received through the antenna unit ANT, and outputs a command signal CMD to the digital unit 140-3.

The power-on reset unit 120-3 detects a power-supply voltage VDD received through the power-supply voltage applying pad P1, and outputs a power-on reset signal POR for controlling a reset operation to the digital unit 140-3. The power-on reset signal POR output from the power-on reset unit 120-3 is input to the DAC register unit 210-3 and the power register 220-3. The clock generator 130-3 outputs a clock signal CLK to the digital unit 140-3. The clock signal CLK controls the digital unit 140-3 in response to the power-supply voltage VDD received from the power-supply voltage applying pad P1.

The digital unit 140-3 interprets the command signal CMD based on the power-supply voltage VDD from the power-supply voltage applying pad P1, a ground voltage GND from the ground voltage applying pad P2, and the power-on reset signal POR, and the clock signal CLK. The digital unit 140-3 generates control signals and processing signals, such that it outputs the response signal RP to the modulator 100-3. The digital unit 140-3 outputs an address ADD, I/O data, a control signal CTR, and the clock signal CLK to the memory unit 150-3.

The digital unit 140-3 outputs I/O data I/O (using m lines (×m)), a write enable signal WE, an output enable signal OE, and a chip enable signal CE to the DAC register unit 210-3, and outputs an operation signal ACT to the power register 220-3. In other words, operation signals received from the external reader pass through the antenna unit ANT, the demodulator 110-3, and the digital unit 140-3, and are input to the DAC register unit 210-3 as the write enable signal WE, the output enable signal OE, and the chip enable signal CE.

The memory unit 150-3 includes a plurality of memory cells, and stores data related to an ID code of each RFID device. Each memory cell writes data in a storage element, and reads data from the storage element.

The memory unit 150-3 includes a non-volatile memory area. Generally, an FeRAM may be used as the non-volatile memory area. The FeRAM has a data processing speed similar to that of DRAM. The FeRAM has a similar structure to that of DRAM, and uses a ferroelectric material as a capacitor. The ferroelectric material has high remnant polarization characteristics, such that data is not lost although an electric field is removed.

In this case, the modulator 100-3, the demodulator 110-3, the power-on reset unit 120-3, the clock generator 130-3, the digital unit 140-3, the memory unit 150-3, and the driving unit 200-3 are driven by the power-supply voltage VDD from the power-supply voltage applying pad P1 and the ground voltage GND from the ground voltage applying pad P2.

In a conventional RFID device, when the RFID device receives the RF signal through communication with the external reader, the power-supply voltage VDD is supplied through a voltage amplification unit provided inside the RFID device. However, in this embodiment, since a large amount of power is consumed by the driving unit 200-3 and the MCU control block 500, the power-supply voltage VDD and the ground voltage GND are provided to the RFID device through the power-supply voltage applying pad P1 and the ground voltage applying pad P2.

The DAC register unit 210-3 outputs driving control signals b1˜bm to the DAC driver 230-3. In this embodiment, the DAC register unit 210-3 includes a non-volatile register. The power register 220-3 outputs a power on/off signal ON/OFF to the DAC driver 230-3 in response to the operation signal ACT and the power-on reset signal POR. The DAC driver 230-3 outputs output signals OUT1˜OUTn through the output pads OP1˜OPn, respectively.

An initial setup value (also called ‘initial set value’) of the DAC register unit 210-3 is established by the RF signal received from the antenna unit ANT. Therefore, if a power source of the RFID device is controlled, or if data stored in the DAC register unit 210-3 is read out, the RF signal received from the antenna unit ANT may be used to change the initial setup value.

The interface unit 510 controls the digital unit 140-3 and the MCU processor 520. In order to program new data in the DAC register unit 210-3 by outputting data programmed by the MCU processor 520 to the DAC register unit 210-3, the programmed data is transmitted to the DAC register 210-3 through the interface unit 510, the digital unit 140-3 and the I/O data bus.

The DAC register unit 210-3 includes an internal register to store data transmitted from the digital unit 140-3. The DAC register unit 210-3 compares set data preset by the RF signal with data stored in the internal register and outputs the driving control signals b1˜bm according to the result of the comparison.

The MCU processor 520 uses a part of the memory unit 150-3 for code data and working data memory. Therefore, it is possible to change the driving control signals b1˜bm of the DAC register 210-3 by changing an internal program of the MCU processor 520. The interface unit 510 may control the digital unit 140-3 and the MCU processor 520.

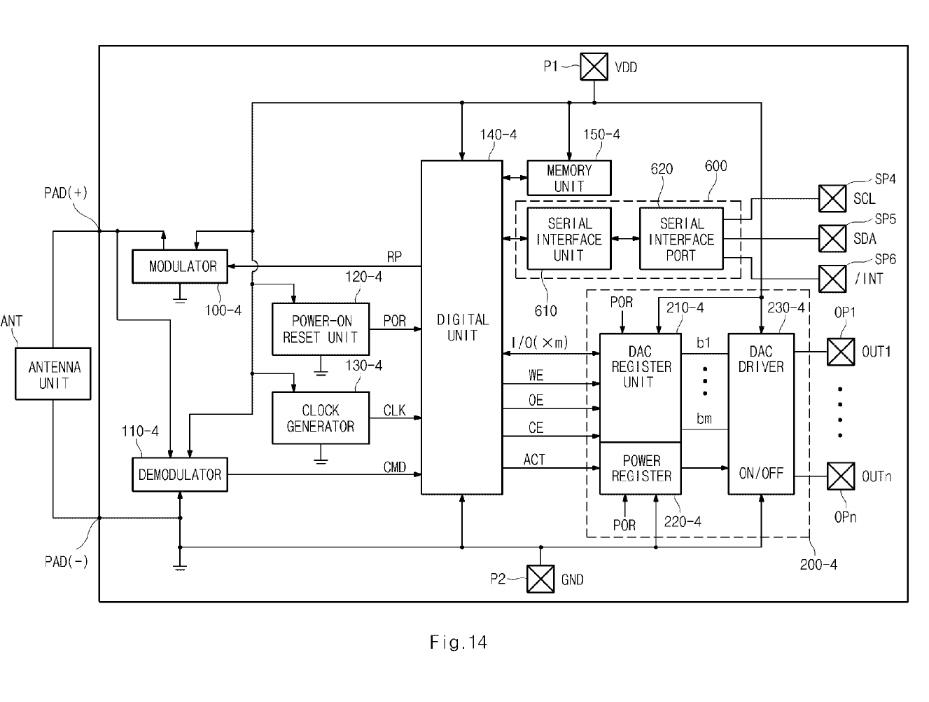

FIG. 14 is a block diagram illustrating an RFID device according to a fifth embodiment of the present invention.

Referring to FIG. 14, the RFID device includes a modulator 100-4, a demodulator 110-4, a power-on reset unit 120-4, a clock generator 130-4, a digital unit 140-4, a memory unit 150-4, a driving unit 200-4, a serial interface controller 600, a power-supply voltage applying pad P1, a ground voltage applying pad P2, a plurality of output pads OP1˜OPn, and a plurality of pads SP4˜SP6.

The driving unit 200-4 includes a DAC register unit 210-4, a power register 220-4, and a DAC driver 230-4. The serial interface controller 600 may include a serial interface unit 610 and a serial interface port 620. In accordance with this embodiment of the present invention, an MCU processor is located outside the RFID device, and the serial interface controller 600 receives a serial interface signal through the pads SP4˜SP6 to program the DAC register unit 210-4 using the received interface signal.

An antenna unit ANT may be used for data communication between an RFID tag, i.e., the RFID device, and an external reader or writer. The antenna unit ANT is coupled to the RFID tag through antenna pads PAD(+) and PAD(−). In this case, an RF signal may be used for the RF communication between the RFID device and the external reader or writer.

The modulator 100-4 modulates a response signal RP received from the digital unit 140-4, and outputs the modulated response signal to the antenna unit ANT. The demodulator 110-4 detects an operation command signal from the RF signal received through the antenna unit ANT, and outputs a command signal CMD to the digital unit 140-4.

The power-on reset unit 120-4 detects a power-supply voltage VDD received through the power-supply voltage applying pad P1, and outputs a power-on reset signal POR for controlling a reset operation to the digital unit 140-4. The power-on reset signal POR output from the power-on reset unit 120-4 is input to the DAC register unit 210-4 and the power register 220-4. The clock generator 130-4 outputs a clock signal CLK to the digital unit 140-4. The clock signal CLK controls the digital unit 140-4 in response to the power-supply voltage VDD received from the power-supply voltage applying pad P1.

The digital unit 140-4 interprets the command signal CMD based on the power-supply voltage VDD from the power-supply voltage applying pad P1, a ground voltage GND from a ground voltage applying pad P2, the power-on reset signal POR, and the clock signal CLK. The digital unit 140-4 generates control signals and processing signals, such that it outputs the response signal RP to the modulator 100-4. Further, the digital unit 140-4 outputs an address ADD, I/O data, a control signal CTR, and the clock signal CLK to the memory unit 150-4.

The digital unit 140-4 outputs I/O data I/O (using m lines (×m)), a write enable signal WE, an output enable signal OE, and a chip enable signal CE to the DAC register unit 210-4, and outputs an operation signal ACT to the power register 220-4. In other words, operation signals received from the external reader pass through the antenna unit ANT, the demodulator 110-4, and the digital unit 140-4, and are input to the DAC register unit 210-4 as the write enable signal WE, the output enable signal OE, and the chip enable signal CE.

The memory unit 150-4 includes a plurality of memory cells, and stores data related to an ID code of each RFID device. Each memory cell writes data in a storage element, and reads data from the storage element.

The memory unit 150-4 includes a non-volatile memory area. Generally, an FeRAM may be used as the non-volatile memory area. The FeRAM has a data processing speed similar to that of DRAM. The FeRAM has a similar structure to that of DRAM, and uses a ferroelectric material as a capacitor. The ferroelectric material has high remnant polarization characteristics, such that data is not lost although an electric field is removed.

In this case, the modulator 100-4, the demodulator 110-4, the power-on reset unit 120-4, the clock generator 130-4, the digital unit 140-4, the memory unit 150-4, and the driving unit 200-4 are driven by the power-supply voltage VDD from the power-supply voltage applying pad P1 and the ground voltage GND from the ground voltage applying pad P2.

In a conventional RFID device, when the RFID device receives the RF signal through communication with the external reader, the power-supply voltage VDD is supplied through a voltage amplification unit provided inside the RFID device. However, in this embodiment, since a large amount of power is consumed by the driving unit 200-4 and the serial interface controller 600, the power-supply voltage VDD and the ground voltage GND are provided to the RFID device through the power-supply voltage applying pad P1 and the ground voltage applying pad P2.

The DAC register unit 210-4 outputs driving control signals b1˜bm to the DAC driver 230-4. In this embodiment, the DAC register unit 210-4 includes a non-volatile register. Therefore, new program data applied to the DAC register unit 210-4 is stored in the register.

The power register 220-4 outputs a power on/off signal ON/OFF to the DAC driver 230-4 in response to the operation signal ACT and the power-on reset signal POR. For example, if a driving object to be controlled by the driving device is an LED, data stored in the power register 220-4 may establish when the LED will be turned on or off after a command signal has been input to the power register 220-4. The DAC driver 230-4 outputs output signals OUT1˜OUTn through the output pads OP1˜OPn, respectively.

An initial setup value (also called ‘initial set value’) of the DAC register unit 210-4 is established by the RF signal received from the antenna unit ANT. Therefore, if a power source of the RFID device is controlled, or if data stored in the DAC register unit 210-4 is read out, the RF signal received from the antenna unit ANT may be used to change the initial setup value.

The serial interface unit 610 controls operation of the digital unit 140-4 and the serial interface port 620. The serial interface port 620 may include an I2C port. The serial interface port 620 controls serial data received from the external MCU processor to perform a serial interface between the RFID device and the external MCU processor. The RFID device includes the pads SP4˜SP6 to perform an interfacing operation with the external MCU processor. The serial interface port 620 receives a clock signal SCL through the pad SP4, data SDA through the pad SP5, and an interrupt signal /INT through the pad SP6.

In this embodiment, the clock signal SCL may be indicative of a serial clock signal used by the I2C port, and the data SDA may be indicative of a serial data open drain used by the I2C port. The interrupt signal /INT may represent an interrupt and data ready signal.

The MCU processor located outside the RFID device generates a signal to drive the DAC register unit 210-4 through its internal program operation. For this purpose, the external MCU processor outputs a programmed code as the serial interface signal to the pads SP4˜SP6.

The programmed code received through the pads SP4˜SP6 is input to the serial interface port 620, and then input to the digital unit 140-4 through the serial interface unit 610. The programmed code from the serial interface unit 610 is transmitted to the DAC register unit 210-4 through the I/O data bus.

In the meantime, the external reader may sometimes recognize a register value of the DAC register unit 210-4. In this case, in order to transmit the register value stored in the DAC register unit 210-4 to the external reader, the stored register value is transmitted to the external reader through the digital unit 140-4, the demodulator 110-4, and the antenna unit ANT.

In contrast, in order to program new data in the DAC register unit 210-4 by using the programmed code transmitted from the external MCU processor, the programmed code received through the pads SP4˜SP6 is input to the serial interface port 620. Then, the digital code data is input to the DAC register unit 210-4 through the serial interface unit 610, the digital unit 140-4, and the I/O data bus.

The DAC register unit 210-4 includes an internal register to store the digital code data received from the digital unit 140-4. In addition, the DAC register unit 210-4 compares set data preset by the RF signal with data stored in the internal register and outputs the driving control signals b1˜bm according to the result of the comparison.

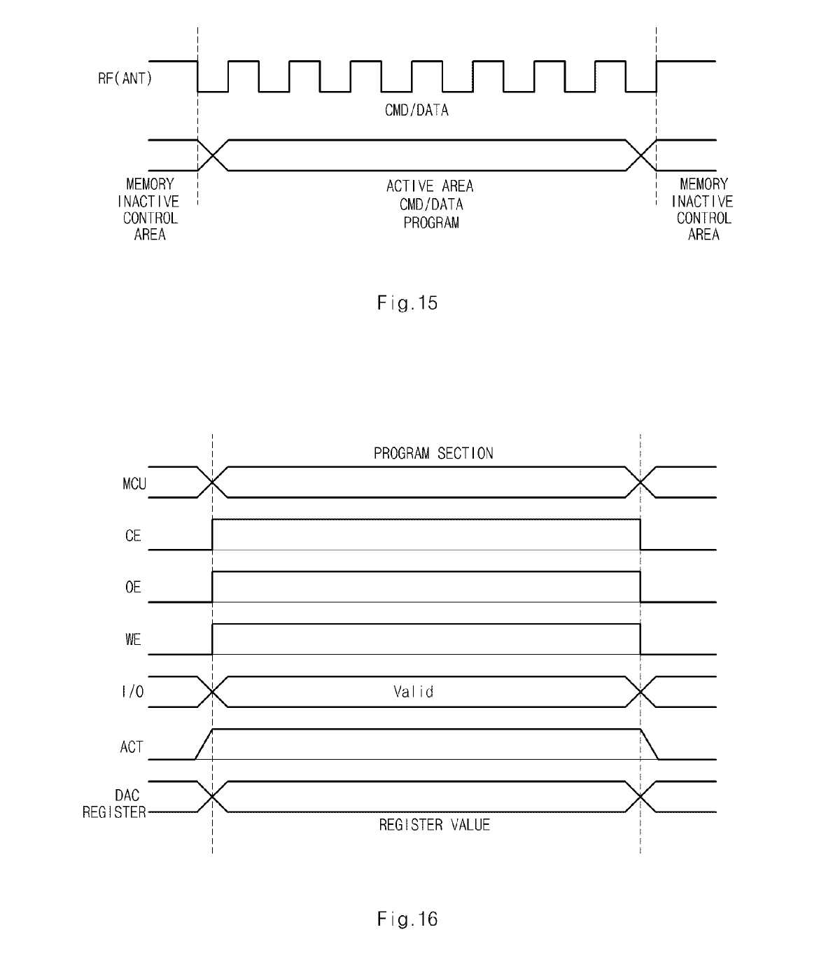

FIG. 15 is a timing diagram illustrating a programming method for the memory unit 150-3 shown in FIG. 13 according to an embodiment of the present invention.

Referring to FIG. 15, if the RFID device receives the RF signal from the antenna unit ANT, the command signal CMD and data DATA are transmitted to the memory unit 150-3 through the demodulator 110-3 and the digital unit 140-3 and programmed in the memory unit 150-3. In other words, in an active area, information including an ID code of the RFID device is pre-programmed in the memory unit 150-3 based on the command signal CMD and the data DATA.

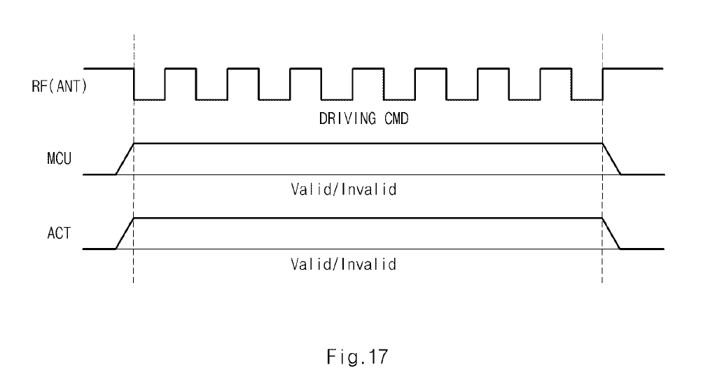

FIG. 16 is a timing diagram illustrating a method for driving the DAC register unit 210-3 according to an embodiment of the present invention.

Referring to FIG. 16, if a program command from the external MCU processor or the internal MCU processor is input to the digital unit 140-3, the digital unit 140-3 activates the chip enable signal CE, the output enable signal OE, and the write enable signal WE, and outputs the activated signals CE, OE and WE.

The chip enable signal CE, the output enable signal OE and the write enable signal WE are input to the DAC register unit 210-3 through the I/O data bus, such that the register value is programmed in the DAC register unit 210-3. In this case, the operation signal ACT is activated such that the power register 220-3 maintains an activation status. As a result, the DAC driver 230-3 starts its operation.

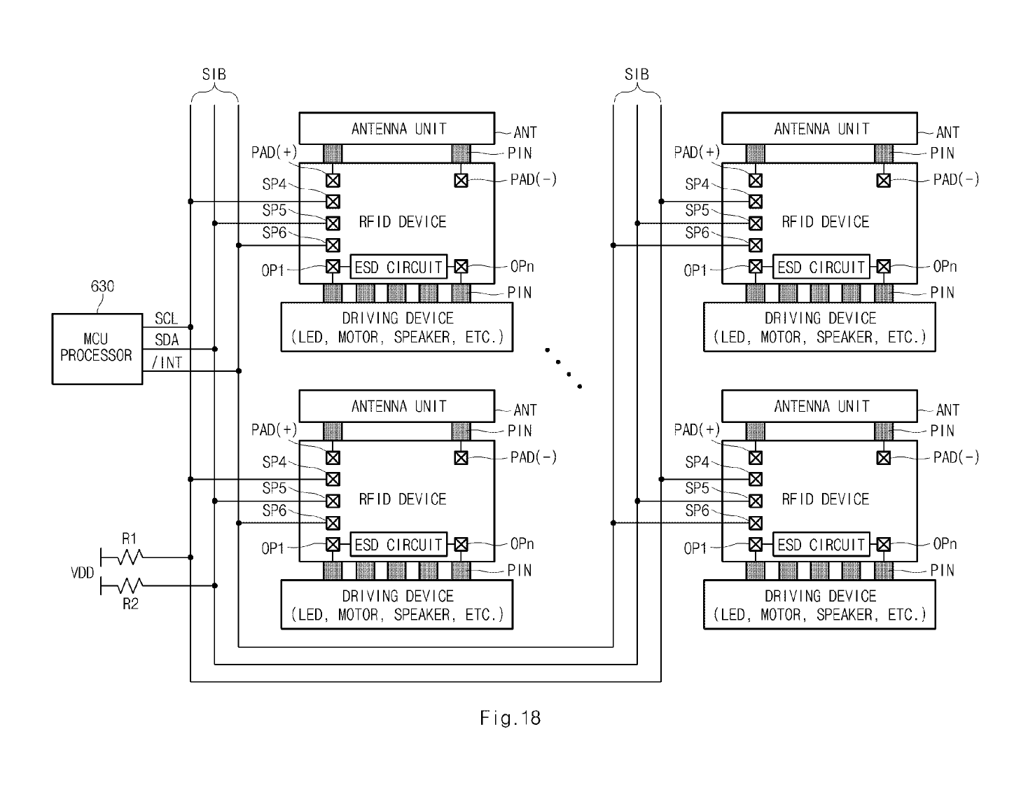

FIG. 17 is a timing diagram illustrating a method for controlling the driving of the RFID device according to an embodiment of the present invention.

Referring to FIG. 17, if the RF signal from the antenna unit ANT is input to the RFID device, and the command signal CMD passes through the demodulator 110-3 and the digital unit 140-3, the operation signal ACT is activated and programmed in the power register 220-3. Meanwhile, if the program command from the external MCU processor or the internal MCU processor is input to the digital unit 140-3, the operation signal ACT is activated. In other words, the operation signal ACT for controlling the power source may be activated by the RF signal received through the antenna unit ANT or the program command from the MCU processor.

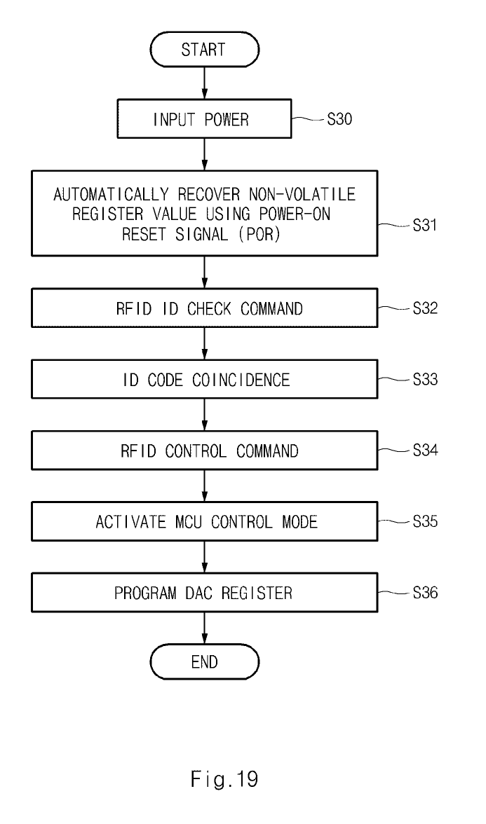

FIG. 18 is a structural view illustrating an RFID system including an external MCU processor 630 according to an embodiment of the present invention.

Referring to FIG. 18, the antenna unit ANT may be coupled to the RFID device through the antenna pads PAD(+) and PAD(−). In other words, the antenna unit ANT may be coupled to the input pins PIN of the RFID device. The RFID device may be coupled to the driving device through the connection pins PIN.

In other words, the output signals OUT1˜OUTn output through the output pads OP1˜OPn of the DAC driver 230-4 are coupled to the driving device through the connection pins PIN. In this case, the driving device may correspond to a driving control device for controlling operations of an LED, a motor, a speaker, etc.

In addition, the RFID device according to the embodiment of the present invention includes an ESD circuit. The ESD circuit is located in the RFID device, and connected to the driving device through the output pads OP1˜OPn and the connection pins PIN.

The MCU processor 630 may be coupled to the RFID device through a serial interface bus SIB at the outside of the RFID device. The program information of the MCU processor 630 is input to the RFID device through the pads SP4˜SP6 of the RFID device.

In accordance with the RFID system of the present invention, a plurality of application devices are arranged in rows and columns. One external MCU processor 630 may be coupled to a plurality of RFID devices through the serial interface bus SIB as shown in FIG. 18.

Resistors R1 and R2 are coupled to a clock (SCL) applying bus and a data (SDA) applying bus. In this case, the resistors R1 and R2 pull the serial interface bus SIB up, such that each of the resistors R1 and R2 may be used as a pull-up load for establishing a default value having a high level.

Generally, the RFID device is characterized as having a small power consumption, a short recognition length, and a rapid recognition speed. In contrast, ZigBee, wireless fidelity (Wi-Fi), and the like serving as a near field communication (NFC) unit among wireless communication protocols are generally applied to a home automations system. A chip size for ZigBee or Wi-Fi serving as the NFC unit is larger than that of the RFID device. For example, the chip size for ZigBee or Wi-Fi serving as the NFC unit may be about ten times larger than that of the RFID device. Therefore, the embodiment of the present invention can remotely control the driving device as well as store the ID code. In accordance with the above-mentioned embodiment of the present invention, the RFID system when used for a device capable of remotely controlling the driving device driving a driving object such as an LED, resulting in a reduction in costs of the remote control device.

In this embodiment of the present invention, for convenience of description and better understanding of the present invention, an entire structure including the modulator 100-4, the demodulator 110-4, the power-on reset unit 120-4, the clock generator 130-4, the digital unit 140-4, the memory unit 150150-4, the driving unit 200-4, and the serial interface controller 600 is referred to as the RFID device. If the external MCU processor 630 is further added to the above-mentioned structure, a structure including the external MCU processor 630 is referred to as the RFID system.

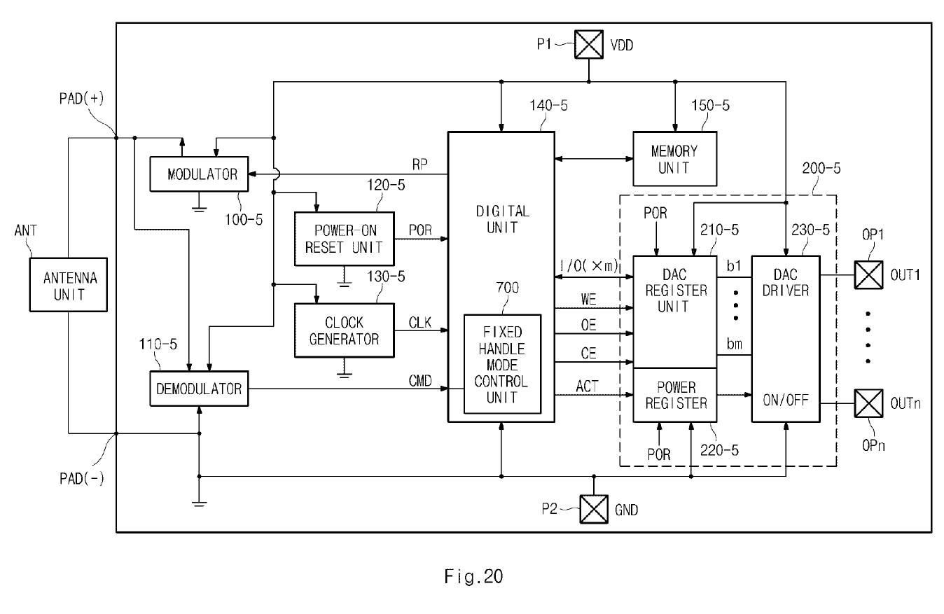

FIG. 19 is a flowchart illustrating an operation of the RFID device shown in FIG. 13 according to an embodiment of the present invention.

Referring to FIG. 19, when the power-supply voltage VDD is input to the RFID device through the power-supply voltage applying pad P1, and the ground voltage GND is input to the RFID device through the ground voltage applying pad P2, the RFID device is powered on at step S30. Thus, the register value of the DAC register unit 210-3 is automatically recovered by the power-on rest signal POR at step S31.

Thereafter, the RFID device receives an RFID check command through the antenna unit ANT, the demodulator 110-3, and the digital unit 140-3 at step S32. When ID code data stored in the memory unit 150-3 is transmitted to the external reader through the digital unit 140-3, the modulator 100-3, and the antenna unit ANT, the external reader determines whether the transmitted ID code data is identical to ID code data corresponding to the RFID device that is pre-stored therein at step S33. If the pre-stored ID code data is identical to the transmitted ID code data, the RFID device is activated and an RFID control command is input to the RFID device through the antenna unit ANT at step S34.

Subsequently, if an MCU control mode is activated at step S35, the program mode of the DAC register unit 210-3 is activated and new data is programmed in the DAC register unit 210-3 in response to the control signals WE, OE and CE received from the digital unit 140-3 at step S36. As the new data is programmed in the DAC register unit 210-3, the driving control signals b1˜bm are changed.

Thereafter, the DAC register unit 210-3 outputs the driving control signals b1˜bm corresponding to the programmed data to the DAC driver 230-3. Thus, the DAC driver 230-3 outputs the output signals OUT1˜OUTn through the output pads OP1˜OPn, respectively.

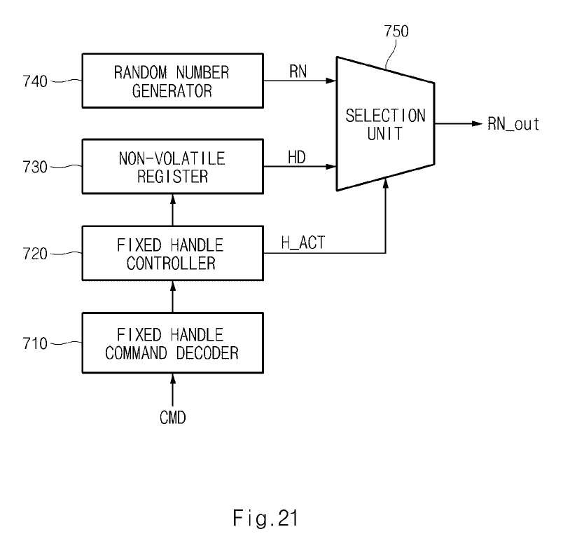

FIG. 20 is a block diagram illustrating an RFID device according to a sixth embodiment of the present invention.

Referring to FIG. 20, the RFID device includes a modulator 100-5, a demodulator 110-5, a power-on reset unit 120-5, a clock generator 130-5, a digital unit 140-5, a memory unit 150-5, a driving unit 200-5, a power-supply voltage applying pad P1, a ground voltage applying pad P2, a plurality of output pads OP1˜OPn, and a fixed handle mode control unit 700.

The driving unit 200-5 includes a DAC register unit 210-5, a power register 220-5, and a DAC driver 230-5. The fixed handle mode control unit 700 may be contained in the digital unit 140-5.

An antenna unit ANT may be used for data communication between an RFID tag, i.e., the RFID device, and an external reader or writer. The antenna unit ANT is coupled to the RFID tag through antenna pads PAD(+) and PAD(−). In this case, an RF signal may be used for the RF communication between the RFID device and the external reader or writer.

The modulator 100-5 modulates a response signal RP received from the digital unit 140-5, and outputs the modulated response signal to the antenna unit ANT. The demodulator 110-5 detects an operation command signal from the RF signal received through the antenna unit ANT, and outputs a command signal CMD to the digital unit 140-5.

The power-on reset unit 120-5 detects a power-supply voltage VDD received through the power-supply voltage applying pad P1, and outputs a power-on reset signal POR for controlling a reset operation to the digital unit 140-5. The power-on reset signal POR output from the power-on reset unit 120-5 is input to the DAC register unit 210-5 and the power register 220-5. The clock generator 130-5 outputs a clock signal CLK to the digital unit 140-5. The signal CLK controls the digital unit 140-5 in response to the power-supply voltage VDD received from the power-supply voltage applying pad P1.

The digital unit 140-5 interprets the command signal CMD based on the power-supply voltage VDD from the power-supply voltage applying pad P1, a ground voltage GND from the ground voltage applying pad P2, and the power-on reset signal POR, and the clock signal CLK. The digital unit 140-5 generates control signals and processing signals, such that it outputs the response signal RP to the modulator 100-5. The digital unit 140-5 outputs an address ADD, I/O data, a control signal CTR, and the clock signal CLK to the memory unit 150-5.

The digital unit 140-5 outputs I/O data I/O (using m lines (×m)), a write enable signal WE, an output enable signal OE, and a chip enable signal CE to the DAC register unit 210-5, and outputs an operation signal ACT to the power register 220-5.

The memory unit 150-5 includes a plurality of memory cells, and stores data related to an ID code of each RFID device. Each memory cell writes data in a storage element, and reads data from the storage element.

The memory unit 150-5 includes a non-volatile memory area. Generally, a FeRAM may be used as the non-volatile memory area. The FeRAM has a data processing speed similar to that of DRAM. The FeRAM has a similar structure to that of DRAM, and uses a ferroelectric material as a capacitor. The ferroelectric material has high remnant polarization characteristics, such that data is not lost although an electric field is removed.

In this case, the modulator 100-5, the demodulator 110-5, the power-on reset unit 120-5, the clock generator 130-5, the digital unit 140-5, the memory unit 150-5, and the driving unit 200-5 are driven by the power-supply voltage VDD from the power-supply voltage applying pad P1 and the ground voltage GND from the ground voltage applying pad P2.

In a conventional RFID device, when the RFID device receives the RF signal through communication with the external reader, the power-supply voltage VDD is supplied through a voltage amplification unit provided inside the RFID device. However, in this embodiment, since a large amount of power is consumed by the driving unit 200-5, the power-supply voltage VDD and the ground voltage GND are provided to the RFID device through the power-supply voltage applying pad P1 and the ground voltage applying pad P2.

The DAC register unit 210-5 outputs driving control signals b1˜bm to the DAC driver 230-5. In this embodiment, the DAC register unit 210-5 includes a non-volatile register. The power register 220-5 outputs a power on/off signal ON/OFF to the DAC driver 230-5 in response to the operation signal ACT and the power-on reset signal POR. The DAC driver 230-5 outputs output signals OUT1˜OUTn through the output pads OP1˜OPn, respectively.

The fixed handle mode control unit 700 may receive the command signal CMD from the demodulator 110-5. In this embodiment, the fixed handle mode control unit 700 may be a circuit block including a random number generator. The fixed handle mode control unit 700 generates a random number in a normal mode. In a fixed handle mode, the fixed handle mode control unit 700 includes a non-volatile register for storing fixed handle data and outputs a fixed handle value.

In accordance with this embodiment of the present invention, a plurality of RFID devices may be arranged in row and column directions, and fixed random numbers may be sequentially assigned to the RFID devices. If there is no fixed handle mode control unit 700 and RFID devices receive a call signal from the external reader, each RFID device may continuously output the response signal RP until the same random number as that of an RFID device desired by the reader is detected. In this case, it takes a long time until the desired RFID device reacts to the call signal.

Therefore, in accordance with an embodiment of the present invention, the order of the plurality of RFID devices responding to the call signal from the external reader is pre-stored in the fixed handle mode control unit 700. In this case, if the RFID device receives the call signal from the external reader, the RFID device may pre-recognize which one of the RFID devices will respond to the call signal. In this embodiment, different fixed handle values may be pre-established in such a manner that the responses of the RFID devices do not overlap.

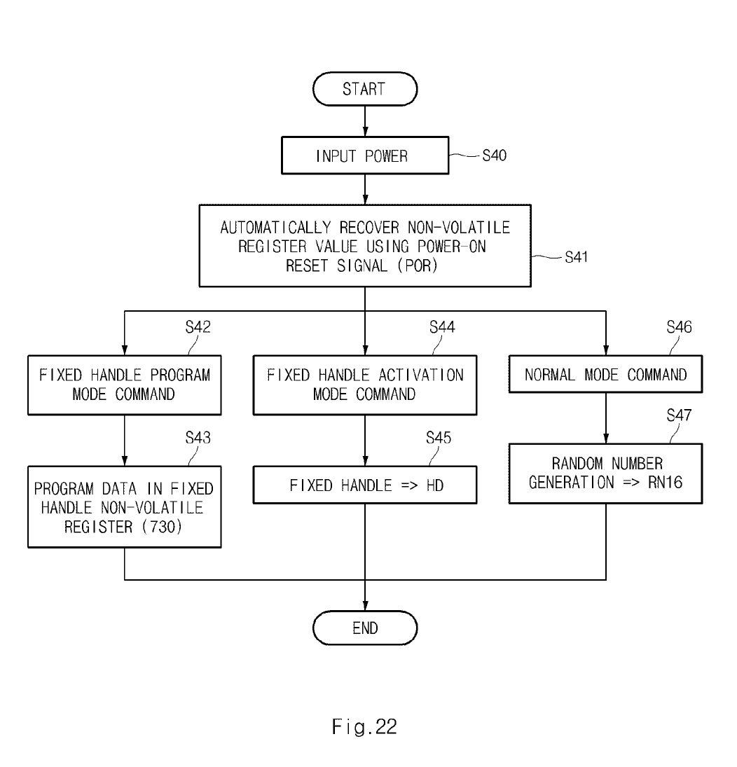

FIG. 21 is a detailed block diagram illustrating the fixed handle mode control unit 700 shown in FIG. 20.

Referring to FIG. 21, the fixed handle mode control unit 700 includes a fixed handle command decoder 710, a fixed handle controller 720, a non-volatile register 730, a random number generator 740, and a selection unit 750.

The fixed handle command decoder 710 decodes the command signal CMD received from the demodulator 110-5, and interprets whether or not the command signal CMD applied to the RFID device is related to the fixed handle control.

An output signal of the fixed handle command decoder 710 may be input to the fixed handle controller 720. If the signal received from the fixed handle command decoder 710 corresponds to the fixed handle mode, the fixed handle controller 720 activates a handle operation signal H_ACT and outputs the activated handle operation signal H_ACT. In contrast, if the signal received from the fixed handle command decoder 710 does not correspond to the fixed handle mode, the fixed handle controller 720 deactivates the handle operation signal H_ACT and outputs the deactivated handle operation signal H_ACT.

The non-volatile register 730 stores a signal received from the fixed handle controller 720 as non-volatile data. That is, the non-volatile register 730 programs new handle data therein. The handle data HD stored in the non-volatile register 730 is output to the selection unit 750. The random number generator 740 generates a random number RN in the normal mode, and outputs the random number RN to the selection unit 750. New handle data is programmed in the fixed handle non-volatile register 730.

The selection unit 750 selects one of the random number RN and the handle data HD in response to the handle operation signal H_ACT from the fixed handle controller 720. The selection unit 750 then outputs an output signal RN_out. The selection unit 750 may include a multiplexer.

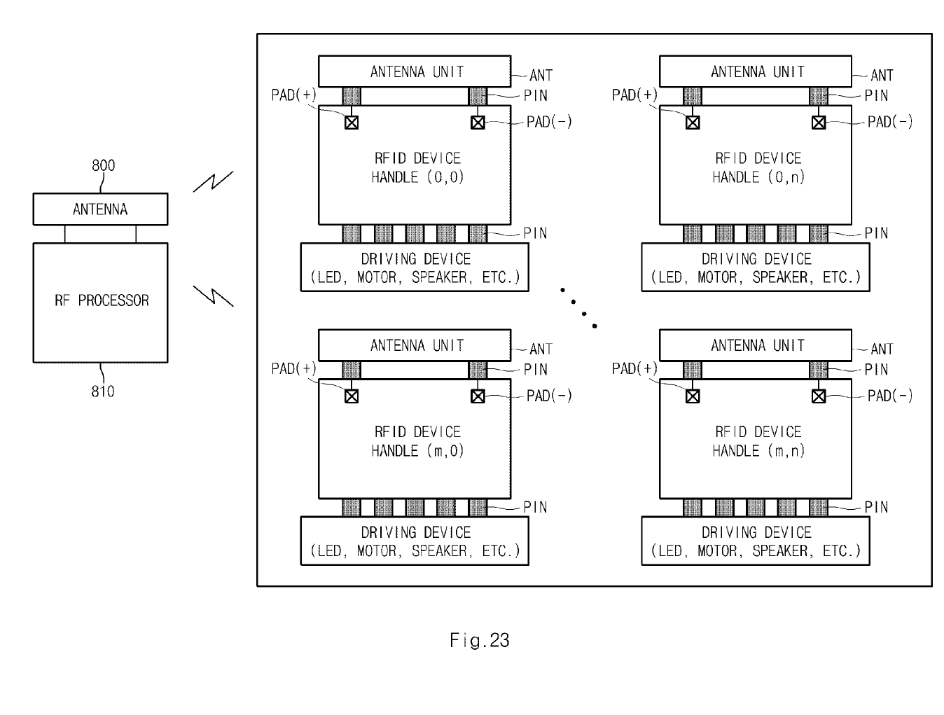

FIG. 22 is a flowchart illustrating an operation of the RFID device shown in FIG. 20.

Referring to FIG. 22, when the power-supply voltage VDD is input to the RFID device through the power-supply voltage applying pad P1 and the ground voltage GND is input to the RFID device through the ground voltage applying pad P2, the RFID device is powered on at step S40. Thus, the register value of the DAC register unit 210-5 is automatically recovered by the power-on reset signal POR at step S41.

In order to set regular handle values in several RFID devices arranged in rows and columns, a fixed handle program mode command is input to the RFID device.

If the command signal CMD received from the demodulator 110-5 is determined to correspond to the fixed handle program mode command at step S42, new handle data is programmed in the fixed handle non-volatile register 730 in response to a control signal of the fixed handle controller 720 at step S43.

In the meantime, in order to use the handle data HD programmed in the non-volatile register 730 or the random number RN in the normal mode as the output signal RN_out, command signals for the following two modes may be input to the RFID device.

First, if the command signal CMD received from the demodulator 110-5 is determined to correspond to a fixed handle activation mode command at step S44, the fixed handle controller 720 activates the handle operation signal H_ACT and outputs the activated signal H_ACT. Therefore, the selection unit 750 selects the fixed handle data HD from the non-volatile register 730, and outputs the selected fixed handle data HD as the output signal RN_out at step S45.

In other words, if the fixed handle activation mode command is input from the demodulator 110-5, the fixed handle data HD of the RFID device that is pre-established in the non-volatile register 730 is output to the outside of the RFID device through the response signal RP.

On the other hand, if the command signal CMD from the demodulator 110-5 is determined to correspond to a normal mode command at step S46, the fixed handle controller 720 deactivates the handle operation signal H_ACT, and outputs the deactivated handle operation signal H_ACT to the selection unit 750. Therefore, the selection unit 750 selects the random number RN generated from the random number generator 740, and outputs the selected random number RN as the output signal RN_out at step S47. RN16, i.e., fixed 16-bit Random Number, data may be established as the random number RN.

The embodiment of the present invention can easily determine an RFID device to be called using the fixed handle data HD pre-established in the fixed handle mode control unit 700. That is, since a fixed ID is assigned to the RFID device using the fixed handle data HD of the fixed handle mode control unit 700, the response order of the RFID devices can be easily recognized.

In this case, the RN16 data may be indicative of a random number of 16 bits. In the normal mode, undefined random data may be output according to the combination of 16-bit data. That is, each of all RFID devices contained in a recognition area of the external reader outputs random RN16 data in response to a call from the external reader, thereby responding to the call of the external reader.

However, since the RN16 data may be a random number arbitrarily generated from the RFID device, it is impossible to predict which data will be generated as the RN16 data.

In the meantime, in accordance with an embodiment of the present invention, the fixed handle data HD is pre-established as a specific value in the non-volatile register 730, and, if the fixed handle activation mode command is input to the RFID device, the specific value pre-established in the non-volatile register 730 is output as the fixed handle data HD. Therefore, after a query command is input to the RFID device, the RFID device outputs the fixed handle data HD pre-established therein to the outside thereof.

In accordance with an embodiment of the present invention, since the response order of the RFID devices is predetermined, it is not necessary that a unique ID code output from each RFID device is changed when a desired RFID device responds.

In other words, since the response order of the RFID devices is predetermined, fixed handle data HD corresponding to a fixed ID is assigned to the fixed handle mode control unit 700 to identify individual RFID devices. If the command signal CMD from the external reader is input to the RFID device, the fixed handle data HD pre-established in the fixed handle mode control unit 700 is output to the external reader. As a result, the external reader needs only to verify whether or not an expected value is output from the called RFID device.

Therefore, if the command signal CMD corresponds to the normal mode command, the multiplexer 750 selects the output of the random number generator 740 and outputs the RN16 data. If the command signal CMD corresponds to the fixed handle activation mode command, the multiplexer 750 selects the output of the non-volatile register 730 and outputs the fixed handle data HD.

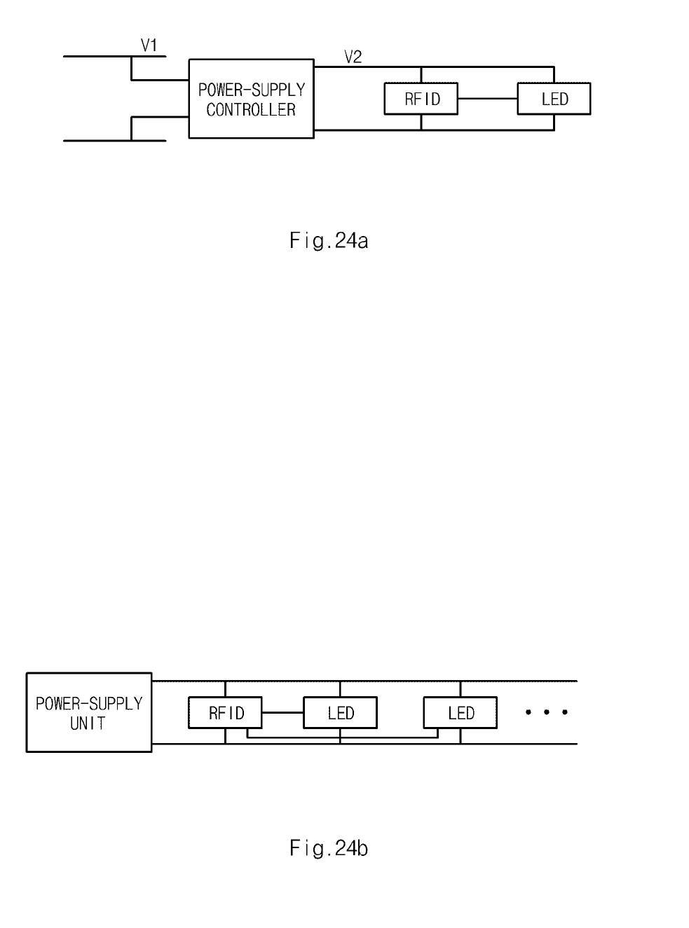

FIG. 23 is a structural view illustrating an RFID system including the fixed handle mode control unit 700.

Referring to FIG. 23, the antenna unit ANT is coupled to the RFID device through the antenna pads PAD(+) and PAD(−). In other words, the antenna unit ANT is coupled to the input pins of the RFID device. In addition, the RFID device is coupled to the driving device through the connection pins PIN.

The output signals OUT1˜OUTn output from the output pads OP1˜OPn of the DAC driver 230-5 are coupled to the driving device through the connection pins PIN. In this case, the driving device may correspond to a driving control device for controlling an LED, a motor, a speaker, and the like.

An RF processor 810 may transmit and receive RF signals to and from the RFID device at the exterior of the RFID device. In other words, an antenna 800 of the RF processor 810 may wirelessly transmit and receive a command signal and data to and from the antenna unit ANT of the RFID device.

In the RFID system, several application devices are arranged in rows and columns. One RF processor 810 may communicate with several RFID devices using RF signals.

In this case, handle data (0, 0)˜handle data (m, n) are sequentially programmed in individual RFID devices, such that a fixed value for a corresponding RFID device may be determined. Therefore, the RF processor 810 activates the fixed handle activation mode command, and transmits the activated fixed handle activation mode command to the RFID device. In this case, the individual RFID devices store their unique handle data (m, n), and thus the RF processor 810 can wirelessly control the individual RFID devices using the handle data (m, n).

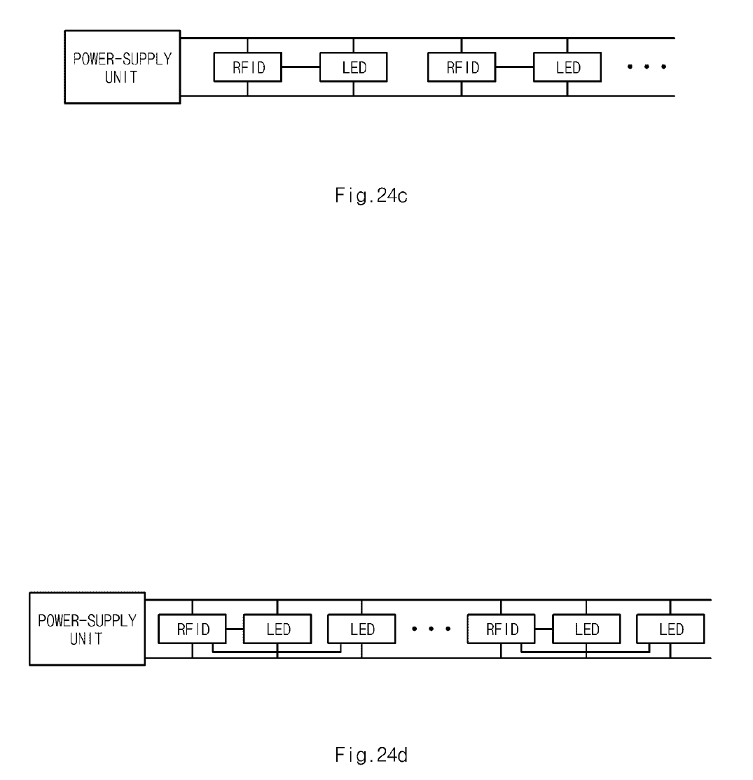

FIGS. 24A to 24D illustrate a power connection relationship between an RFID device and a driving device to be used as a driving object according to embodiments of the present invention. FIGS. 24A to 24D exemplarily illustrate that the driving object to be driven by the driving device is an LED.

FIG. 24A illustrates that an external power-supply voltage V1 is converted to a power-supply voltage V2 by a power-supply controller, and the power-supply voltage V2 is provided to the RFID device and the LED of the RFID system. For example, the external power-supply voltage V1 is set to 220V, and the power-supply voltage V2 is set to 3.3V. The power-supply controller may include a voltage converter or a transformer.

FIG. 24A illustrates that a single power-supply voltage is provided to a single RFID device. FIG. 24B illustrates that an RFID system for allowing one RFID device to simultaneously control several LEDs is powered on by a power-supply unit.

Referring to FIG. 24C, one RFID device is coupled to one LED, and an RFID system including several pairs of RFID devices and LEDs is powered on by a power-supply unit. Referring to FIG. 24D, an LED group including several LEDs are coupled to one RFID device, and an RFID system including the RFID devices and their corresponding LED groups is powered on by a power-supply unit.

In recent times, an illumination lamp installed in a building or the like may generally include a plurality of LED elements. In this case, several LED elements are respectively turned on or off so that the on/off control result appears as a specific light pattern. In addition, each illumination lamp may be controlled to have a desired brightness, or a certain illumination lamp arranged at a desired position may be separately controlled.

The above-mentioned scheme for controlling the illumination lamp may remotely control the illumination lamp using the RFID device. In other words, if an RFID tag is attached to each LED and a desired RF signal is transmitted to each RFID tag through an external reader, the RFID tag attached to the LED recognizes the transmitted RF signal and receives an additional command according to a unique ID. In this way, the number and brightness of the LEDs can be controller as desired. The RFID tag is relatively cheaper than a general wireless remote controller. Accordingly, if the RFID tag is applied to the illumination lamp, the implementation cost can be reduced and more options can be provided to the users.

As apparent from the above description, the RFID system according to the above-mentioned embodiments of the present invention have the following effects.

First, the embodiment of the present invention relates to an RFID technology for allocating an identification (ID) code to a driving device using an RFID device such that each driving device can be wirelessly controlled at a remote site.

Second, the embodiment of the present invention relates to an RFID technology for allocating an ID code to each driving device using an RFID device including an internal or external sensor, and transmitting a specific driving command to each RFID device using an RF signal, thus establishing a specific output level.

Third, the embodiment of the present invention relates to an RFID technology for allocating an ID code to each driving device using an RFID device including an internal MCU or an external MCU, and transmitting a specific driving command to each RFID device using an RF signal, thus establishing a specific output level.

Fourth, the embodiment of the present invention relates to an RFID device for predetermining handle values to a plurality of RFID devices using a fixed handle mode, and allowing each RFID device to be arbitrarily selected and controlled using the corresponding predetermined handle value, thus increasing the operational efficiency.

Although a number of illustrative embodiments consistent with the invention have been described, it should be understood that numerous other modifications and embodiments can be devised by those skilled in the art that will fall within the spirit and scope of the principles of this disclosure. Particularly, numerous variations and modifications are possible in the component parts and/or arrangements which are within the scope of the disclosure, the drawings and the accompanying claims. In addition to variations and modifications in the component parts and/or arrangements, alternative uses will also be apparent to those skilled in the art.

What is claimed is:

1. A radio frequency identification (RFID) system, comprising:
an RFID device configured to read and write data in response to a radio frequency (RF) signal received through an antenna unit,
wherein the RFID device includes:
a connection unit coupled to an external driving device; and
a driving unit configured to output a driving signal to the connection unit in response to control signals generated by the RF signal, the driving signal being output to the connection unit in order to control the external driving device.

2. The RFID system according to claim 1, wherein the driving unit includes:
a register unit configured to output a driving control signal in response to the control signals; and
a digital analog converter (DAC) driver configured to convert the driving control signal received from the register unit into an analog signal and output the analog signal as the driving signal.

3. The RFID system according to claim 2, wherein the register unit includes:
a buffer configured to buffer input/output (I/O) data;
a register controller configured to generate a register control signal according to the control signals and a power-on reset signal;
a register configured to store the I/O data in response to the register control signal; and
a register output unit configured to generate the driving control signal in response to output data of the register.

4. The RFID system according to claim 3, wherein the register includes:
a pull-up unit configured to provide a power-supply voltage in response to a pull-up enable signal;
a first latch unit configured to latch data of first and second ends of a cell using the power-supply voltage;
an input/output (I/O) unit configured to provide the I/O data to the first and second ends of the cell in response to a write enable signal;
a non-volatile ferroelectric capacitor configured to store the data of the first and second ends of the cell as non-volatile data in response to a cell plate signal;
a second latch unit configured to latch the data of the first and second ends of the cell using a ground voltage; and
a pull-down unit configured to provide the ground voltage in response to a pull-down enable signal.

5. The RFID system according to claim 2, wherein the driving unit further includes:
a power register configured to control a power source of the DAC driver in response to an operation signal generated by the RF signal and a power-on reset signal.

6. The RFID system according to claim 1, wherein the RFID device further includes:
a demodulator configured to output a command signal by demodulating the RF signal;
a power-on reset unit configured to output a power-on reset signal by detecting a power-supply voltage;
a clock generator configured to generate a clock signal in response to the power-supply voltage;
a modulator configured to modulate a response signal, and output the modulated response signal to the antenna unit;
a digital unit configured to interpret a command signal generated by the RF signal, and output the control signals to the driving unit; and
a memory unit configured to store an identification (ID) code wherein the memory unit includes a non-volatile ferroelectric memory.

7. The RFID system according to claim 1, wherein the RFID device further includes:
a power-supply voltage applying pad configured to provide a power-supply voltage to the RFID device; and
a ground voltage applying pad configured to provide a ground voltage to the RFID device.

8. The RFID system according to claim 1, wherein the connection unit includes:
an output pad coupled to the driving device through a connection pin.

9. The RFID system according to claim 1, wherein a driving object to be controlled by the driving device includes any one of a light emitting diode (LED), a motor, and a speaker.

10. The RFID system according to claim 1, wherein the RFID device further includes an electrostatic discharge (ESD) circuit.

11. A radio frequency identification (RFID) system comprising:
an RFID device configured to read and write data in response to a radio frequency (RF) signal received through an antenna unit,
wherein the RFID device includes:
a connection unit coupled to an external driving device;
a sensor control block configured to convert a sensing value detected by a sensing element into digital code data, and output the digital code data; and
a driving unit configured to output a driving signal for controlling the external driving device to the connection unit according to the digital code data and control signals generated by the RF signal.

12. The RFID system according to claim 11, wherein the sensor control block includes:
a sensing unit configured to include the sensing element so as to detect the sensing value;
a sensing signal processor configured to compensate for an offset of the sensing value detected by the sensing unit, and amplify the compensated sensing value;
an analog digital converter (ADC) configured to convert an output signal of the sensing signal processor into the digital code data; and
a sensing controller configured to control operations of the sensing signal processor and the ADC.

13. The RFID system according to claim 11, wherein the driving unit includes:
a register unit configured to store the digital code data and output a driving control signal in response to the control signals; and
a digital analog converter (DAC) driver configured to convert the driving control signal received from the register unit into an analog signal and output the analog signal as the driving signal.

14. The RFID system according to claim 13, wherein the driving unit further includes:
a power register configured to control a power source of the DAC driver in response to an operation signal generated by the RF signal and a power-on reset signal.

15. The RFID system according to claim 11, wherein the RFID device further includes:
a demodulator configured to output a command signal by demodulating the RF signal;
a power-on reset unit configured to output a power-on reset signal by detecting a power-supply voltage;
a clock generator configured to generate a clock signal in response to the power-supply voltage;
a modulator configured to modulate a response signal, and output the modulated response signal to the antenna unit;
a digital unit configured to interpret a command signal generated by the RF signal, and output the control signals to the driving unit; and
a memory unit configured to store an identification (ID) code, wherein the memory unit includes a non-volatile ferroelectric memory.

16. The RFID system according to claim 11, wherein the RFID device further includes:
a power-supply voltage applying pad configured to provide a power-supply voltage to the RFID device; and
a ground voltage applying pad configured to provide a ground voltage to the RFID device.

17. The RFID system according to claim 11, wherein the connection unit includes:
an output pad coupled to the external driving device through a connection pin.

18. The RFID system according to claim 11, wherein the RFID device further includes an ESD circuit.

19. A radio frequency identification (RFID) system comprising:
an RFID device configured to read and write data according to a radio frequency (RF) signal received through an antenna unit,
wherein the RFID device includes:
a connection unit coupled to an external driving device;
a sensor interface unit configured to receive a sensing signal from an external sensor; and
a driving unit configured to output a driving signal for controlling the external driving device to the connection unit in response to an output signal of the sensor interface unit and control signals generated by the RF signal.

20. The RFID system according to claim 19, wherein the RFID device further includes:
a digital unit configured to process the sensing signal received through the sensor interface unit, and output the processed sensing signal to the driving unit.

21. The RFID device according to claim 20, wherein the RFID device further includes:
a sensing pad configured to transmit the sensing signal received from the sensor to the sensor interface unit.

22. The RFID system according to claim 21, wherein the sensing pad includes:
a first sensing pad configured to receive a serial clock signal;
a second sensing pad configured to receive serial data; and
a third sensing pad configured to receive an interrupt signal.

23. The RFID system according to claim 19, wherein the sensor interface unit includes:
a serial interface port configured to receive the sensing signal; and
a sensing controller configured to control the serial interface port.

24. The RFID system according to claim 19, wherein the driving unit includes:
a register unit configured to store sensing data received from the sensor interface unit and output a driving control signal; and
a digital analog converter (DAC) driver configured to convert the driving control signal received from the register unit into an analog signal and output the analog signal as the driving signal.

25. The RFID system according to claim 24, wherein the driving unit further includes:
a power register configured to control a power source of the DAC driver in response to an operation signal generated by the RF signal and a power-on reset signal.

26. The RFID system according to claim 19, wherein the RFID device further includes:
a demodulator configured to output a command signal by demodulating the RF signal;
a power-on reset unit configured to output a power-on reset signal by detecting a power-supply voltage;
a clock generator configured to generate a clock signal in response to the power-supply voltage;
a modulator configured to modulate a response signal, and output the modulated response signal to the antenna unit; and
a memory unit configured to store an identification (ID) code, wherein the memory unit includes a non-volatile ferroelectric memory.

27. The RFID system according to claim 19, wherein the RFID device further includes:
a power-supply voltage applying pad configured to provide a power-supply voltage to the RFID device; and
a ground voltage applying pad configured to provide a ground voltage to the RFID device.

28. The RFID system according to claim 19, wherein the connection unit includes:
an output pad coupled to the external driving device through a connection pin.

29. The RFID system according to claim 19, wherein the RFID device further includes an ESD circuit.

30. A radio frequency identification (RFID) system, comprising:
an RFID device configured to read and write data in response to a radio frequency (RF) signal received through an antenna unit,
wherein the RFID device includes:
a connection unit coupled to an external driving device;
a micro-controller unit (MCU) control block configured to program code data and output programmed code data; and
a driving unit configured to output a driving signal for controlling the external driving device to the connection unit according to the programmed code data and control signals generated by the RF signal.

31. The RFID system according to claim 30, wherein the RFID device further includes:
a digital unit configured to process the programmed code data received from the MCU control block, and output the processed code data to the driving unit.

32. The RFID system according to claim 31, wherein the MCU control block includes:
an MCU processor configured to program the code data; and
an interface unit configured to control operations of the digital unit and the MCU processor.

33. The RFID system according to claim 30, wherein the driving unit includes:
a register unit configured to store the programmed code data and output a driving control signal; and
a digital analog converter (DAC) driver configured to convert the driving control signal received from the register unit into an analog signal and output the analog signal as the driving signal.

34. The RFID system according to claim 33, wherein the driving unit further includes:
a power register configured to control a power source of the DAC driver in response to an operation signal generated by the RF signal and a power-on reset signal.

35. The RFID system according to claim 30, wherein the RFID device further includes:
a demodulator configured to output a command signal by demodulating the RF signal;
a power-on reset unit configured to output a power-on reset signal by detecting a power-supply voltage;
a clock generator configured to generate a clock signal in response to the power-supply voltage; and
a modulator configured to modulate a response signal, and output the modulated response signal to the antenna unit.

36. The RFID system according to claim 30, wherein the RFID device further includes:
a power-supply voltage applying pad configured to provide a power-supply voltage to the RFID device; and
a ground voltage applying pad configured to provide a ground voltage to the RFID device.

37. The RFID system according to claim 30, wherein the connection unit includes:
an output pad coupled to the external driving device through a connection pin.

38. The RFID system according to claim 30, wherein the RFID device further includes an ESD circuit.

39. A radio frequency identification (RFID) system comprising:
an RFID device configured to read and write data according to an RF signal received through an antenna unit,
wherein the RFID device includes:
a connection unit coupled to an external driving device;
a serial interface controller configured to receive code data from an external MCU processor; and
a driving unit configured to output a driving signal for controlling the external driving device to the connection unit in response to an output signal of the serial interface controller and control signals generated by the RF signal.

40. The RFID system according to claim 39, wherein the RFID device further includes:
a digital unit configured to process the code data received from the serial interface controller, and output the processed code data to the driving unit.

41. The RFID system according to claim 39, wherein the RFID device further includes:
a pad configured to transmit the code data received from the MCU processor to the serial interface controller.

42. The RFID system according to claim 41, wherein the pad includes:
a first pad configured to receive a serial clock signal;
a second pad configured to receive serial data; and
a third pad configured to receive an interrupt signal.

43. The RFID system according to claim 39, wherein the serial interface controller includes:
a serial interface port configured to receive the code data; and
a serial interface unit configured to control the serial interface port.

44. The RFID system according to claim 39, wherein the driving unit includes:
a register unit configured to store the code data received from the serial interface controller and output a driving control signal; and
a DAC driver configured to convert the driving control signal received from the register unit into an analog signal and output the analog signal as the driving signal.

45. The RFID system according to claim 44, wherein the driving unit further includes:
a power register configured to control a power source of the DAC driver in response to an operation signal generated by the RF signal and a power-on reset signal.

46. The RFID system according to claim 39, wherein the RFID device further includes:
a demodulator configured to output a command signal by demodulating the RF signal;
a power-on reset unit configured to output a power-on reset signal by detecting a power-supply voltage;
a clock generator configured to generate a clock signal in response to the power-supply voltage;
a modulator configured to modulate a response signal, and output the modulated response signal to the antenna unit; and
a memory unit configured to store an identification (ID) code, wherein the memory unit includes a non-volatile ferroelectric memory.

47. The RFID system according to claim 39, wherein the RFID device further includes:
a power-supply voltage applying pad configured to provide a power-supply voltage to the RFID device; and
a ground voltage applying pad configured to provide a ground voltage to the RFID device.

48. The RFID system according to claim 39, wherein the RFID device further includes an ESD circuit.

49. A radio frequency identification (RFID) system comprising:
an RFID device configured to read and write data in response to a radio frequency (RF) signal received through an antenna unit,
wherein the RFID device includes:
a connection unit coupled to an external driving device;
a driving unit configured to output a driving signal for controlling the external driving device to the connection unit according to control signals generated by the RF signal; and
a fixed handle mode control unit configured to output predetermined fixed handle data in a fixed handle mode according to a command signal generated by the RF signal.

50. The RFID system according to claim 49, wherein the fixed handle mode control unit includes:
a fixed handle command decoder configured to decode the command signal;
a fixed handle controller configured to control activation of a handle operation signal in response to an output signal of the fixed handle command decoder;
a register configured to store output data of the fixed handle controller as non-volatile data and output the fixed handle data;
a random number generator configured to generate a random number; and
a selection unit configured to select one of the random number and the fixed handle data in response to the handle operation signal, and output the selected one.

51. The RFID system according to claim 49, further comprising:
a plurality of RFID devices configured to be arranged in row and column directions such that fixed handle data is differently pre-established in the RFID devices.

52. The RFID system according to claim 51, further comprising:
a radio frequency (RF) processor configured to pre-establish fixed handle data of regular values in the RFID devices using the RF signal.

53. The RFID system according to claim 49, wherein the driving unit includes:
a register unit configured to output a driving control signal in response to the control signals; and
a DAC driver configured to convert the driving control signal received from the register unit into an analog signal and output the analog signal as the driving signal.

54. The RFID system according to claim 53, wherein the driving unit further includes:
a power register configured to control a power source of the DAC driver in response to an operation signal generated by the RF signal and a power-on reset signal.

55. The RFID system according to claim 49, wherein the RFID device further includes:
a demodulator configured to output a command signal by demodulating the RF signal;
a power-on reset unit configured to output a power-on reset signal by detecting a power-supply voltage;
a clock generator configured to generate a clock signal in response to the power-supply voltage;
a modulator configured to modulate a response signal, and output the modulated response signal to the antenna unit;
a digital unit configured to interpret a command signal generated according to the RF signal, and output the control signals to the driving unit; and
a memory unit configured to store an identification (ID) code,
wherein the memory unit includes a non-volatile ferroelectric memory.

56. The RFID system according to claim 49, wherein the RFID device further includes:
a power-supply voltage applying pad configured to provide a power-supply voltage to the RFID device; and
a ground voltage applying pad configured to provide a ground voltage to the RFID device.

57. The RFID system according to claim 49, wherein the connection unit includes:
an output pad coupled to the external driving device through a connection pin.
